(19) United States
(12) Patent Application Publication
(10) Pub. No.: US 2016/0223706 A1
(43) Pub. Date: Aug. 4, 2016

(54) Non-Intrusive Inspection Systems and Methods for the Detection of Materials of Interest

(71) Applicant: Rapiscan Systems, Inc., Torrance, CA (US)

(72) Inventors: Edward D. Franco, San Mateo, CA (US); Willem G.J. Langeveld, Menlo Park, CA (US); Joseph Bendahan, San Jose, CA (US); Martin Janecek, Sunnyvale, CA (US); Dan Strellis, San Jose, CA (US)

(21) Appl. No.: 14/996,018

(22) Filed: Jan. 14, 2016

Related U.S. Application Data
(60) Provisional application No. 62/104,158, filed on Jan. 16, 2015.

(51) Int. Cl. G01V 5/00; G21K 1/02

(52) U.S. Cl. CPC G01V 5/0025; G01V 5/0041; G01V 5/005; G21K 1/02

(57) ABSTRACT

The present specification discloses methods for inspecting liquids, aerosols and gels (LAGs) for threats. The method includes scanning LAGs packed in plastic bags in a multiple step process. In a primary scan, the bag is scanned using dual energy CT technique with fan beam radiation. In case of an alarm, the alarming LAG container is scanned again using coherent X-ray scatter technique with cone beam radiation. The system has a mechanism to switch between two collimators to produce either fan beam or cone beam. The system also has a mechanism to position the target properly for scanning and prevent container overlap when scanning multiple LAG containers in a bag.

### CROSS-REFERENCE

The present specification relies on U.S. Patent Provisional Application No. 62/104,158, entitled “Non-Intrusive Inspection Systems and Methods for the Detection of Materials of Interest”, and filed on Jan. 16, 2015, which is incorporated herein by reference.

### FIELD

The present specification generally relates to the field of radiant energy imaging systems, and more specifically to a system that uses a combination of X-ray coherent scatter, diffraction, and multi-energy transmission X-ray radiation technologies for detecting concealed objects and identifying materials of interest, particularly liquids, aerosols and gels in containers.

### BACKGROUND

The quantities of liquids, aerosols, and gels (LAGs) allowed on passenger aircraft have been restricted since the discovery that terrorists had the ability carry out attacks using liquid, homemade, and improvised explosives. There is interest among the aviation authorities to remove these restrictions, thus creating a need for methods and devices that simultaneously analyze the contents of closed containers of varying sizes and materials in order to automatically detect and distinguish explosive and flammable liquids (pure or mixed with fuel) from benign liquids (drinks, lotions, hygiene products, and food items among others). An effective bottled liquid scanner technology should be able to perform the collective screening for threats concealed in LAGs containers, within baggage or divested in plastic bags, and also be capable of screening LAGs in single container configurations of various sizes.

It is well-known by those of ordinary skill in the art that effective atomic number (Z_{eff}) and density (ρ) are two primary physical attributes of materials that are used to classify explosive threats concealed in baggage and in other containers. Classification algorithms that use these attributes are incorporated into many of the X-ray based automated explosive detection systems and checkpoint screening systems currently deployed in airports around the world.

X-ray inspection systems currently available in the art provide limited capability for screening LAGs. The materials of interest include explosives in the form of solids, liquids, aerosols, gels, and explosives precursors in a variety of container types including plastic, glass, metal, and foil. The container may be transparent or opaque and may be itself contained within an outer package. Detecting such materials, which could potentially be used to make a weapon, is a very complex task. LAG threats in particular, span a relatively narrow range of Z_{eff} and ρ values that are close to common benign items. The problem is further compounded when the contents of multiple closed containers of varying sizes and materials that are packed in bags need to be simultaneously analyzed, such as during baggage screening at airports, or in screening divested LAGS contained in quart, gallon, or secure tamper evident bags. Such items also present a challenge to screening, as the various containers are likely to overlap, from any particular point of view.

Currently, there are four principal technologies available for screening LAGS without opening the container containing the potential threat item: 1) Raman scattering of laser light; 2) measurement of the dielectric constant; 3) dual-energy X-ray radiographic imaging; and, 4) computed tomography (CT) techniques. These conventional methods for screening for LAGS are not without their drawbacks, however. Raman scattering of laser light produces a signature that is characteristic of the chemical composition of the LAG. However, this is a single point measurement and cannot be used to simultaneously screen multiple containers. Additionally, this technique may not work for opaque containers and will not work for metallic or nested containers. Thus, Raman scattering may not be used to screen LAGs contained within many types of packaging.

The dielectric constant of a LAG, measured in an electromagnetic field, can be used as a signature that is quite characteristic of the LAG. This measurement technique, however, has higher than desired false alarm rates, cannot be used to simultaneously screen multiple containers, and cannot be used to screen LAGS in metallic containers.

Dual-energy X-ray radiographic imaging technologies can be used to measure the Z_{eff} and ρ of the LAG where that information is then used to classify the LAG as benign or as a threat. These systems have been certified by aviation authorities for the screening of LAGS when the containers are presented in a controlled orientation and without overlapping materials. Radiographic methods, however, are limited since they do not address the problem of container overlap and are not designed to screen containers packed in bags. They are not capable of simultaneously screening multiple containers in a bag and they have an operationally high false alarm rate. This reduces the screening throughput since passengers have to divest the LAGS, place them in a special bin in a preferred orientation for screening, and the transportation security officers have to resolve the operationally high level of false alarms.

Finally, CT technology provides a method for simultaneously screening multiple containers that is relatively insensitive to the shape or composition of the container. CT can accurately determine the Z_{eff} and ρ of the LAG when implemented with dual-energy (DE) or multiple-energy (ME) detectors. For example, U.S. Pat. No. 8,036,337 describes “[a] method for security-inspection of a liquid article with dual-energy CT, comprising the steps of: acquiring dual-energy projection data by dual-energy CT scanning on the liquid article to be inspected; performing CT reconstruction on the projection data to obtain a CT image which indicates physical attributes of the inspected liquid article; extracting the physical attributes of the inspected liquid article based on the CT image; and determining whether the inspected liquid article is dangerous according to the physical attributes.”

Further, U.S. Pat. No. 8,320,523 describes “[a] method of inspecting a liquid article comprising: performing a DR imaging on the liquid article to generate a transmission image; determining from the transmission image at least one positions at which CT scan is to be performed; performing dual-energy CT scan at the determined positions to generate CT image data; determining a density and atomic number from the generated CT image data; judging whether at least one point defined by the density and the atomic number determined from the CT image data falls into a predetermined region in a two-dimensional space of density-atomic number; and outputting information indicative of that the liquid article is dangerous or not.”

The expanding list of liquid, homemade, and improvised explosive threats reduces the separation between benign and threat items and is leading to an increasing number of overlaps in Z_{eff} and ρ between threat and benign LAGs. CT-based methods, however, do not measure the Z_{eff} and CT number (approximate density, ρ) with sufficient accuracy or precision to avoid feature overlaps with some benign materials, leading to false alarms.

There is a need for additional orthogonal signatures that can be used to classify materials that overlap in Z_{eff} and ρ. One signature of interest is coherent X-ray scatter (hereinafter may be referred to as CXS′), which produces a characteristic signature of the molecular structure of the item under examination. This signature is orthogonal to and independent of Z_{eff} and ρ.

CXS is well known in the current art. For example, U.S. Pat. No. 5,265,144 discloses “[an] X-ray apparatus, comprising a polychromatic X-ray source for generating a primary beam of limited cross-section along a primary beam path, an energy-sensitive detector means comprising a central detector element situated in the primary beam path and a sequence of detector elements arranged on rings of successively increasing diameter surrounding said primary beam for detecting scattered radiation generated by elastic scattering processes in the primary beam path, a collimator means between the X-ray source and the sequence of detector elements and which encloses the primary beam, said collimator means being constructed in a manner that scattered radiation from said elastic scattering processes occurring within a given portion of the primary beam path is incident on a plurality of said sequence of detector elements, and further comprising means for determining a pulse transfer spectrum from energy spectra of X-ray quanta incident on the respective detector elements of said sequence which are normalized to an energy spectrum of X-ray quanta incident on the central detector element.”

U.S. Pat. No. 5,642,393 describes “[an] inspection system for detecting a specific material of interest in items of baggage or packages, comprising: a multi-view X-ray inspection probe constructed to employ X-ray radiation transmitted through or scattered from an examined item to identify a suspicious region inside said examined item; said multi-view X-ray inspection probe constructed to identify said suspicious region using several examination angles of said transmitted or scattered X-ray radiation, and also constructed to obtain spatial information of said suspicious region and to determine a geometry for subsequent examination; an interface system constructed and arranged to receive from said X-ray inspection probe data providing said spatial information and said geometry; a directional, material sensitive probe connected to and receiving from said interface system said spatial information and said geometry; said material sensitive probe constructed to acquire material specific information about said suspicious region by employing said geometry; and a computer constructed to process said material specific information to identify presence of said specific material in said suspicious region.”

Accordingly, there is still a need for an improved explosive threat detection system, particularly for LAG threats, that captures data through an X-ray system and utilizes this data to identify threat items in a rapid, yet accurate, manner. The improved detection and resolution system should be able to precisely clear or confirm alarms generated by explosives detection systems resulting from the inspection of carry-on and checked luggage and other objects. There is further a need for determining the presence of potential threat materials, regardless of the shape and composition of containers of such materials. Such a system needs to be highly threat specific, so as to reliably and discern threat materials, while at the same time maintaining a high scan throughput. It is to such a system that the present specification is directed.

### SUMMARY

The present specification describes the use of a coherent X-ray scatter signature, along with Zeff and ρ as determined from radiography or CT, to screen LAGs.

In some embodiments, the present specification discloses a system for scanning an object, the system comprising: an X-ray source for generating radiation; a first scanning subsystem comprising: a first collimator for limiting the radiation to produce a beam that irradiates the object; a first array of transmission detectors to generate first transmittance scan data corresponding to detected beam radiation transmitted through the object, wherein the object is rotated about an axis perpendicular to the beam relative to said first array of transmission detectors; a second scanning subsystem comprising: a second collimator for limiting the radiation to produce a shaped beam that irradiates the object; at least one detector to generate scatter scan data corresponding to detected shaped beam radiation scattered from the object; and a processor that uses the first transmittance scan data and the scatter scan data to determine a presence of a material of interest within the object.

Optionally, a first detector in the second scanning subsystem is energy sensitive.

Optionally, a second detector is used to measure transmitted radiation through the object in the second scanning subsystem to normalize the scatter scan data, wherein the second detector is energy sensitive.

In some embodiments, an attenuator comprising of a pinhole, a filter or a scatterer is used to reduce an intensity of the beam produced by the first collimator.

Optionally, the first scanning subsystem is a multi-energy transmission system.

Optionally, the X-ray source is switched between a low and a high energy to generate dual-energy transmission data in the first scanning subsystem.

In some embodiments, the beam produced by the first collimator is a fan beam. In some embodiments, the object is rotated, in increments, by a total angle which is at least a sum of a fan angle of the fan beam and 180 degrees to produce a computed-tomographic image.

Optionally, the first scanning subsystem is a multi-energy CT system.

Optionally, the processor uses the first transmittance scan data to calculate an effective atomic number and density of voxels within the object and uses the scatter scan data to generate a diffraction signature.

Optionally, the processor uses a combination of all or some of the following to determine whether the object contains a material of interest: the diffraction signature, density and effective atomic number.

In some embodiments, the material of interest is one of explosives and drugs. In some embodiments, the object is a bag containing a combination of liquids, emulsions and gels in individual containers.

Optionally the shaped beam of the second scanning subsystem is a pencil beam. Still optionally, the shaped beam of the second scanning subsystem is a ring or a cone shaped beam.

In some embodiments, the present specification discloses a method of scanning a container containing at least one item, the method comprising: generating radiation from an X-ray source; producing a single or multi-energy radiograph of the container; analyzing the radiograph to determine a location of an object of interest within the container and using said location for a first transmittance scan; positioning a first collimator for limiting the radiation to produce a beam that irradiates the container at the location; detecting the first transmittance scan data, using a first array of transmission detectors, corresponding to detected beam radiation transmitted through the container, wherein the container is rotated about an axis perpendicular to the beam relative to the first array of transmission detectors; calculating properties of the at least one item in the container using the first transmittance scan data; generating an alarm if the at least one item is suspected as an item of interest using the calculated properties; positioning a second collimator for limiting the radiation to produce a shaped beam that irradiates the item of interest; detecting scatter scan data, using at least one detector, corresponding to detected shaped beam radiation scattered from the item; generating a diffraction signature; and confirming the at least one item of the container as an item of interest by using a combination of the diffraction signature and the calculated properties.

Optionally, a first detector for detecting scatter scan data is energy sensitive.

Optionally, a second detector is used to measure transmitted radiation through the item to normalize the scatter scan data. Optionally, the second detector is energy sensitive.

In some embodiments, an attenuator comprising of a pinhole, a filter or a scatterer is used to reduce an intensity of the beam produced by the first collimator.

Optionally, the first transmittance scan data is a multi-energy transmission scan data.

Optionally, the first transmittance scan data is dual-energy transmission data generated by switching the X-ray source between a low and a high energy.

In some embodiments, the beam produced by the first collimator is a fan beam. In some embodiments, the container is rotated, in increments, by a total angle which is at least a sum of a fan angle of the fan beam and 180 degrees to produce a computed-tomographic image.

Optionally, the first transmittance scan data is generated using a multi-energy CT system.

Optionally, the properties comprise an effective atomic number and density of voxels within the at least one item calculated using the first transmittance scan data.

In some embodiments, the item of interest is one of explosives and drugs. In some embodiments, the container contains a combination of liquids, emulsions and gels in individual containers.

Optionally, the shaped beam that generates the scatter scan data is a pencil beam. Still optionally, the shaped beam that generates the scatter scan data is a ring or a cone shaped beam. In some embodiments, the present specification discloses a system for scanning an object, the system comprising: an X-ray source for generating radiation; and, a first scanning subsystem comprising: a first collimator for limiting the radiation to produce a fan beam that irradiates the object; and, a first array of transmission detectors to generate first transmittance scan data corresponding to detected fan beam radiation transmitted through the object, wherein the object is rotated about an axis perpendicular to the fan beam; a second scanning subsystem comprising: a second collimator for limiting the radiation to produce a shaped beam that irradiates the object; and at least one energy-sensitive detector to generate scatter scan data corresponding to detected shaped beam radiation scattered from the object.

Optionally, a second energy-sensitive detector is used to measure transmitted radiation through the object in the second scanning subsystem.

In some embodiments, an attenuator comprising of a filter or a scatterer may be used to reduce a counting rate of the second energy-sensitive detector.

Optionally, the first scanning subsystem is a dual-energy transmission system. Still optionally, the X-ray source is switched between a low and a high energy to generate dual-energy transmission data.

Optionally, said first array of transmission detectors are dual-energy stacked detectors. Still optionally, said first array of transmission detectors are energy-sensitive detectors.

In some embodiments, the object may be rotated, in increments, by a total angle which is at least a sum of a fan angle of the fan beam and 180 degrees to produce a computed-tomographic image.

In some embodiments, the first scanning subsystem may be a dual-energy CT system.

Optionally, a processor uses said first transmittance scan data to calculate an effective atomic number and density of voxels within the object and uses said scatter scan data to generate a diffraction signature. Still optionally, the processor uses the diffraction signature and at least one of said density and effective atomic number to determine whether the object contains a material of interest.

In some embodiments, the material of interest may be one of explosives and drugs. In some embodiments, the object may be a bag containing a combination of liquids, emulsions and gels in individual containers.

Optionally, the shaped beam is a pencil beam. Still optionally, the shaped beam is a ring or cone shaped beam.

In some embodiments, the present specification discloses a system for scanning an object, the system comprising: an X-ray source for generating radiation from a first source position and a second source position; a first scanning subsystem comprising: a first collimator for limiting the radiation generated by the X-ray source from the first source position to produce a fan beam that irradiates the object in a first object position; and, a first array of transmission detectors to generate first transmittance scan data corresponding to detected fan beam radiation transmitted through the object in said first object position, wherein the object in said first object position is rotated about an axis perpendicular to the fan beam; and a second scanning subsystem comprising: a second collimator for limiting the radiation generated by the X-ray source from the second source position to produce a shaped beam that irradiates the object in a second object position; and at least one energy-sensitive detector to generate scatter scan data corresponding to detected shaped beam radiation scattered from the object in said second object position.

Optionally, a second energy-sensitive detector is used to measure transmitted radiation through the object in the second scanning subsystem.

In some embodiments, an attenuator comprising of a filter or a scatterer may be used to reduce a counting rate of the second energy-sensitive detector.

Optionally, the first scanning subsystem is a dual-energy transmission system. Still optionally, the X-ray source is switched between a low and a high energy to generate dual-energy transmission data.

Optionally, the first array of transmission detectors are dual-energy stacked detectors. Still optionally, the first array of transmission detectors are energy-sensitive detectors.

In some embodiments, the object may be rotated, in increments, by a total angle which is at least a sum of a fan angle of the fan beam and 180 degrees to produce a computed-tomographic image.

In some embodiments, the first scanning subsystem is a dual-energy CT system.

Optionally, a processor uses said first transmittance scan data to calculate an effective atomic number and density of voxels within the object and uses said scatter scan data to generate a diffraction signature. Still optionally, the processor uses the diffraction signature and at least one of said density and effective atomic number to determine whether the object contains a material of interest.

In some embodiments, the material of interest may be one of explosives and drugs. In some embodiments, the object may be a bag containing a combination of liquids, emulsions and gels in individual containers.

Optionally, the shaped beam is a pencil beam. Still optionally, the shaped beam is a ring or cone shaped beam.

In some embodiments, the present specification is directed toward a system for scanning an object containing at least one item, the system comprising: an X-ray source for generating radiation; a first scanning subsystem comprising: a first collimator for limiting the radiation to produce a fan beam that irradiates the object; a first array of transmission detectors to generate first transmittance scan data corresponding to detected fan beam radiation transmitted through the object, wherein the object is rotated about an axis perpendicular to the fan beam; a second scanning subsystem comprising: a second collimator for limiting the radiation to produce a shaped beam that irradiates the object; and, at least one energy-sensitive detector to generate scatter scan data corresponding to detected shaped beam radiation scattered from the object; and a processor that: uses said first transmittance scan data to calculate a density of the object; uses said scatter scan data to generate a diffraction signature; and uses a combination of said density and said diffraction signature to confirm said at least one item as a material of interest.

In some embodiments, the present specification is directed toward a system for scanning an object containing at least one item, the system comprising: an X-ray source for generating radiation from a first source position and a second source position; a first scanning subsystem comprising: a first collimator for limiting the radiation generated by the X-ray source from the first source position to produce a fan beam that irradiates the object in a first object position; a first array of transmission detectors to generate first transmittance scan data corresponding to detected fan beam radiation transmitted through the object in said first object position, wherein the object in said first object position is rotated about an axis perpendicular to the fan beam; and a second scanning subsystem comprising: a second collimator for limiting the radiation generated by the X-ray source from the second source position to produce a shaped beam that irradiates the object in a second object position; at least one energy-sensitive detector to generate scatter scan data corresponding to detected shaped beam radiation scattered from the object in said second object position; and a processor that: uses said first transmittance scan data to calculate a density of the object; uses said scatter scan data to generate a diffraction signature; and uses a combination of said density and said diffraction signature to confirm said at least one item as a material of interest.

In some embodiments, the present specification is directed toward a system for scanning an object, the system comprising: an X-ray source for generating radiation having at least one energy or dual energy; a first scanning subsystem comprising: a first collimator for limiting the radiation to produce a fan beam that irradiates the object; a first array of transmission detectors to generate first transmittance scan data corresponding to detected fan beam radiation transmitted through the object, wherein the object is rotated about an axis perpendicular to the fan beam; a second scanning subsystem comprising: a second collimator for limiting the radiation to produce a shaped beam that irradiates the object; and at least one energy-sensitive detector to generate scatter scan data corresponding to detected shaped beam radiation scattered from the object.

In some embodiments, an energy-sensitive detector may be used to measure transmitted radiation through the object in the second scanning subsystem.

Optionally, an attenuator comprising a filter or a scatterer may be used to reduce a counting rate of the energy-sensitive detector.

In some embodiments, said first array of transmission detectors may be dual-energy stacked detectors when said X-ray source generates radiation having a single energy.

Optionally, the object is rotated, in increments, by a total angle which is a sum of a fan angle of the fan beam and 180 degrees to produce a computed-tomographic image.

Optionally, the first scanning subsystem is a dual-energy CT system.

Optionally, a processor uses said first transmittance scan data to calculate an effective atomic number and density of voxels within the object and uses said scatter scan data to generate a diffraction signature. Still optionally, the processor uses the diffraction signature and at least one of said density and effective atomic number to determine whether the object contains a material of interest.

In some embodiments, the material of interest may be one of explosives and drugs. In some embodiments, the object may be a bag containing a combination of liquids, emulsions and gels in individual containers.

Optionally, the shaped beam is a pencil beam. Still optionally, the shaped beam is a ring or cone shaped beam.

In some embodiments, the present specification is directed toward a system for scanning an object, the system comprising: an X-ray source for generating radiation, having at least one energy or dual energy, from a first source position and a second source position; a first scanning subsystem comprising: a first collimator for limiting the radiation generated by the X-ray source from the first source position to produce a fan beam that irradiates the object in a first object position; a first array of transmission detectors to generate first transmittance scan data corresponding to detected fan beam radiation transmitted through the object in said first object position, wherein the object in said first object position is rotated about an axis perpendicular to the fan beam; and a second scanning subsystem comprising: a second collimator for limiting the radiation generated by the X-ray source from the second source position to produce a shaped beam that irradiates the object in a second object position; and at least one energy-sensitive detector to generate scatter scan data corresponding to detected shaped beam radiation scattered from the object in said second object position.

Optionally, an energy-sensitive detector is used to measure transmitted radiation through the object in the second scanning subsystem.

Optionally, an attenuator comprising a filter or a scatterer is used to reduce a counting rate of the energy-sensitive detector.

Optionally, said first array of transmission detectors are dual-energy stacked detectors when said X-ray source generates radiation having a single energy.

In some embodiments, the object may be rotated, in increments, by a total angle which is a sum of a fan angle of the fan beam and 180 degrees to produce a computed-tomographic image.

Optionally, the first scanning subsystem is a dual-energy CT system.

Optionally, a processor uses said first transmittance scan data to calculate an effective atomic number and density of voxels within the object and uses said scatter scan data to generate a diffraction signature. Still optionally, a processor uses the diffraction signature and at least one of said density and effective atomic number to determine whether the object contains a material of interest.

In some embodiments, the material of interest may be one of explosives and drugs. In some embodiments, the object may be a bag containing a combination of liquids, emulsions and gels in individual containers.

Optionally, the shaped beam is a pencil beam. Still optionally, the shaped beam is a ring or cone shaped beam.

In some embodiments, the present specification discloses a system for scanning an object containing at least one item, the system comprising: an X-ray source for generating radiation having at least one energy or dual energy; a first scanning subsystem comprising: a first collimator for limiting the radiation to produce a fan beam that irradiates the object; and a first array of transmission detectors to generate first transmittance scan data corresponding to detected fan beam radiation transmitted through the object, wherein the object is rotated about an axis perpendicular to the fan beam; a second scanning subsystem comprising: a second collimator for limiting the radiation to produce a shaped beam that irradiates the object; and at least one energy-sensitive detector to generate scatter scan data corresponding to detected shaped beam radiation scattered from the object; and a processor that: uses said first transmittance scan data to calculate an effective atomic number and density of voxels within the object; uses said scatter scan data to generate a diffraction signature; and uses a combination of said diffraction signature and at least one of said effective number and density to confirm said at least one item as a material of interest.

In some embodiments, the present specification is directed towards a system for scanning an object containing at least one item, the system comprising: an X-ray source for generating radiation, having at least one energy or dual energy, from a first source position and a second source position; a first scanning subsystem comprising: a first collimator for limiting the radiation generated by the X-ray source from the first source position to produce a fan beam that irradiates the object in a first object position; a first array of transmission detectors to generate first transmittance scan data corresponding to detected fan beam radiation transmitted through the object in said first object position, wherein the object in said first object position is rotated about an axis perpendicular to the fan beam; a second scanning subsystem comprising: a second collimator for limiting the radiation generated by the X-ray source from the second source position to produce a shaped beam that irradiates the object in a second object position; at least one energy-sensitive detector to generate scatter scan data corresponding to detected shaped beam radiation scattered from the object in said second object position; and a processor that: uses said first transmittance scan data to calculate an effective atomic number and a density of voxels within the object; uses said scatter scan data to generate a diffraction signature; and uses a combination of said diffraction signature and at least one of said effective number and density to confirm said at least one item as a material of interest.

In some embodiments, the present specification discloses a method of scanning a container containing at least one item, the method comprising: generating radiation from an X-ray source; producing a single or multi-energy radiograph of the container; analyzing the radiograph to determine a location of an object of interest within the container and using said location for a first transmittance scan; positioning a first collimator for limiting the radiation to produce a fan beam that irradiates the container at said location determined by analyzing the radiograph; detecting said first transmittance scan data, using a first array of transmission detectors, corresponding to detected fan beam radiation transmitted through the container, wherein the container is rotated about an axis perpendicular to the fan beam; calculating a density of said at least one item in the container using said first transmittance scan data; generating an alarm if said at least one item is suspected as a threat using said calculated density; positioning a second collimator for limiting the radiation to produce a shaped beam that irradiates the alarming item; detecting scatter scan data, using at least one energy-sensitive detectors, corresponding to detected shaped beam radiation scattered from the item; generating a diffraction signature; and confirming said at least one item of the container as threat or non-threat by using a combination of said diffraction signature and said calculated density.

Optionally, the method further includes detecting second transmittance scan data simultaneously along with said scatter scan data, using a second array of transmission detectors, corresponding to detected attenuated radiation transmitted through the container and an attenuator positioned before the second array of transmission detectors.

In some embodiments, said diffraction signature may be generated by correcting said scatter scan data using said second transmission scan data.

Optionally, the attenuator is a filter or a scatterer.

Optionally, a detector collimator is placed before said array of scatter detectors.

Optionally, the first transmittance scan data corresponds to dual-energy transmission scanning. Still optionally, the X-ray source is switched between a low and a high energy to generate dual-energy.

Optionally, the first array of transmission detectors are dual-energy stacked detectors. Still optionally, the first array of transmission detectors are energy-sensitive detectors.

In some embodiments, the container may be rotated, incrementally, by a total angle which is at least a sum of a fan angle of the fan beam and 180 degrees to produce a computed-tomographic image. Optionally, the container is rotated by 360 degrees about the axis perpendicular to the fan beam.

Optionally, the first transmittance scan data corresponds to dual-energy CT scanning.

Optionally, the shaped beam is a pencil beam. Still optionally, the shaped beam is a ring or cone-shaped beam.

In some embodiments, the present specification discloses a method of scanning a container containing at least one item, the method comprising: generating radiation from an X-ray source in a first source position; producing a single or multi-energy radiograph of the container; analyzing the radiograph to determine a location of an object of interest within the container and using said location for a first transmittance scan; positioning a first collimator for limiting the radiation to produce a fan beam that irradiates the container in a first container position and at said location determined by analyzing the radiograph; detecting first transmittance scan data, using a first array of transmission detectors, corresponding to detected fan beam radiation transmitted through the container in said first container position, wherein the container in said first container position is rotated about an axis perpendicular to the fan beam; calculating a density of said at least one item in the container using said first transmittance scan data; generating an alarm if said at least one item is suspected as threat using said density; moving the container to a second container position; positioning a second collimator for limiting the radiation, generated by the X-ray source in said second position, to produce a shaped beam that irradiates the container in said second position; detecting scatter scan data, using at least one energy-sensitive detectors, corresponding to detected shaped beam radiation scattered from the object in said second position; generating a diffraction signature; and confirming said at least one item of the container as threat or non-threat by using a combination of said diffraction signature and said density.

In some embodiments, the method further comprises detecting second transmittance scan data simultaneously along with said scatter scan data, using a second array of transmission detectors, corresponding to detected attenuated radiation transmitted through the container in said second container position and an attenuator positioned before the second array of transmission detectors.

In some embodiments, said diffraction signature is generated by correcting said scatter scan data using said second transmission scan data.

Optionally, the attenuator is a filter or a scatterer.

Optionally, the method further comprises placing a detector collimator before said array of scatter detectors.

Optionally, the first transmittance scan data corresponds to dual-energy transmission scanning. Still optionally, the X-ray source is switched between a low and a high energy to generate dual-energy.

Optionally, the first array of transmission detectors are dual-energy stacked detectors. Still optionally, the first array of transmission detectors are energy-sensitive detectors.

Optionally, the container is rotated, incrementally, by a total angle which is at least sum of a fan angle of the fan beam and 180 degrees to produce a computed-tomographic image. Still optionally, the container is rotated by 360 degrees about the axis perpendicular to the fan beam.

In some embodiments, the first transmittance scan data corresponds to dual-energy CT scanning.

Optionally, the shaped beam is a pencil beam. Still optionally, the shaped beam is a ring or a cone shaped beam.

In some embodiments, the present specification discloses a method of scanning a container containing at least one item, the method comprising: generating radiation, having at least one energy or dual-energy, from an X-ray source; producing a dual-energy radiograph of the container; analyzing the radiograph to determine a location of an object of interest within the container and using said location for a first transmittance scan; positioning a first collimator at said location determined by analyzing the radiograph for limiting the radiation to produce a fan beam that irradiates the container; detecting first transmittance scan data, using a first array of transmission detectors, corresponding to detected fan beam radiation transmitted through the container, wherein the container is rotated about an axis perpendicular to the fan beam; calculating an effective atomic number and density of said at least one item in the container using said first transmittance scan data; generating an alarm if said at least one item is suspected as threat using at least one of said effective atomic number and density; positioning a second collimator for limiting the radiation to produce a shaped beam that irradiates the alarming item; detecting scatter scan data, using at least one energy-sensitive detector, corresponding to detected shaped beam radiation scattered from the item; generating a diffraction signature; and confirming said at least one item of the container as threat or non-threat by using a combination of said diffraction signature and at least one of said effective atomic number and density.

In some embodiments, the present specification discloses a method of scanning a container containing at least one item, the method comprising: generating radiation, having at least one energy or dual energy, from an X-ray source in a first source position; producing a dual-energy radiograph of the container; analyzing the radiograph to determine a location of an object of interest within the container and using said location for a first transmittance scan; positioning a first collimator at said location determined by analyzing the radiograph for limiting the radiation to produce a fan beam that irradiates the container in a first container position; detecting first transmittance scan data, using a first array of transmission detectors, corresponding to detected fan beam radiation transmitted through the container in said first container position, wherein the container in said first container position is rotated about an axis perpendicular to the fan beam; calculating an effective atomic number and density of said at least one item in the container using said first transmittance scan data; generating an alarm if said at least one item is suspected as threat using at least one of said effective atomic number and density; moving the container to a second container position; positioning a second collimator for limiting the radiation, generated by the X-ray source in said second position, to produce a shaped beam that irradiates the container in said second position; detecting scatter scan data, using at least one energy-sensitive detectors, corresponding to detected shaped beam radiation scattered from the object in said second position; generating a diffraction signature; and confirming said at least one item of the container as threat or non-threat by using a combination of said diffraction signature and at least one of said effective atomic number and density.

In some embodiments, the present specification discloses a method of scanning a container containing at least one item, the method comprising: generating radiation from an X-ray source; positioning a first collimator for limiting the radiation to produce a fan beam that irradiates the container; detecting first transmittance scan data, using a first array of transmission detectors, corresponding to detected fan beam radiation transmitted through the container, wherein the container is rotated about an axis perpendicular to the fan beam; calculating a density of the container using said first transmittance scan data; generating an alarm if said at least one item is suspected as threat using said density; positioning a second collimator for limiting the radiation to produce a shaped beam that irradiates the container; detecting scatter scan data, using at least one energy-sensitive detector, corresponding to detected shaped beam radiation scattered from the object; detecting second transmittance scan data, using a second array of transmission detectors, corresponding to detected attenuated radiation transmitted through the container and an attenuator positioned before the second array of transmission detectors, wherein said scatter scan data and said second transmittance scan data are obtained simultaneously; generating a diffraction signature by correcting said scatter scan data using said second transmission scan data; and confirming said at least one item of the container as threat or non-threat by using a combination of said diffraction signature and said density.

Optionally, the attenuator is a filter or a scatterer.

In some embodiments, a detector collimator may be placed before said array of scatter detectors.

Optionally, said first array of transmission detectors are energy sensitive detectors.

Optionally, the container is rotated, incrementally, by a total angle which is at least a sum of a fan angle of the fan beam and 180 degrees to produce a computed-tomographic image. Still optionally, the object is rotated by 360 degrees about the axis perpendicular to the fan beam.

Optionally, the shaped beam is a pencil beam. Still optionally, the shaped beam is a ring or cone shaped beam.

Optionally, the first collimator is positioned at a location determined by generating and analyzing a single or multi-energy radiograph of the container.

In some embodiments, the present specification is directed toward a method of scanning a container containing at least one item, the method comprising: generating radiation from an X-ray source in a first source position; positioning a first collimator for limiting the radiation to produce a fan beam that irradiates the container in a first container position; detecting first transmittance scan data, using a first array of transmission detectors, corresponding to detected fan beam radiation transmitted through the container in said first container position, wherein the container in said first container position is rotated about an axis perpendicular to the fan beam; calculating a density of the container using said first transmittance scan data; generating an alarm if said at least one item is suspected as threat using said density; moving the X-ray source to a second source position to generate radiation; moving the container to a second container position; positioning a second collimator for limiting the radiation, generated by the X-ray source in said second position, to produce a shaped beam that irradiates the container in said second position; detecting scatter scan data, using an array of scatter detectors, corresponding to detected shaped beam radiation scattered from the object in said second position; detecting second transmittance scan data, using a second array of transmission detectors, corresponding to detected attenuated radiation transmitted through the container in said second container position and an attenuator positioned before the second array of transmission detectors, wherein said scatter scan data and said second transmittance scan data are obtained simultaneously; generating a diffraction signature by correcting said scatter scan data using said second transmission scan data; and confirming said at least one item of the container as threat or non-threat by using a combination of said diffraction signature and said density.

Optionally, the attenuator is a filter or a scatterer.

Optionally, a detector collimator may be placed before said array of scatter detectors.

Optionally, the first array of transmission detectors are energy sensitive detectors.

Optionally, the container is rotated, in increments, by a total angle which is at least sum of a fan angle of the fan beam and 180 degrees to produce a computed-tomographic image. Still optionally, the object is rotated by 360 degrees about the axis perpendicular to the fan beam.

Optionally, the shaped beam is a pencil beam. Still optionally, the shaped beam is a ring or cone shaped beam.

Optionally, the first collimator is positioned at a location determined by generating and analyzing a single or multi-energy radiograph of the container.

In some embodiments, the present specification discloses a method of scanning a container containing at least one item, the method comprising: generating radiation, having at least one energy or dual energy, from an X-ray source; positioning a first collimator for limiting the radiation to produce a fan beam that irradiates the container; detecting first transmittance scan data, using a first array of transmission detectors, corresponding to detected fan beam radiation transmitted through the container, wherein the container is rotated about an axis perpendicular to the fan beam; calculating an effective atomic number and density of the container using said first transmittance scan data; generating an alarm if said at least one item is suspected as threat using at least one of said effective atomic number and density; positioning a second collimator for limiting the radiation to produce a shaped beam that irradiates the container; detecting scatter scan data, using at least one energy-sensitive detector, corresponding to detected shaped beam radiation scattered from the object; detecting second transmittance scan data, using a second array of transmission detectors, corresponding to detected attenuated radiation transmitted through the container and an attenuator positioned before the second array of transmission detectors, wherein said scatter scan data and said second transmittance scan data are obtained simultaneously; generating a diffraction signature by correcting said scatter scan data using said second transmission scan data; and confirming said at least one item of the container as threat or non-threat by using a combination of said diffraction signature and at least one of said effective number and density.

Optionally, the attenuator is a filter or a scatterer.

Optionally, the method further comprises placing a detector collimator before said array of scatter detectors.

Optionally, the container is rotated, in increments, by a total angle which is at least a sum of a fan angle of the fan beam and 180 degrees to produce a computed-tomographic image. Still optionally, the object is rotated by 360 degrees about the axis perpendicular to the fan beam.

Optionally, the shaped beam is a pencil beam. Still optionally, the shaped beam is a ring or cone shaped beam.

Optionally, the first collimator is positioned at a location determined by generating and analyzing a dual energy radiograph of the container.

In some embodiments, the present specification discloses a method of scanning a container containing at least one item, the method comprising: generating radiation, having at least one energy or dual energy, from an X-ray source in a first source position; positioning a first collimator for limiting the radiation to produce a fan beam that irradiates the container in a first container position; detecting first transmittance scan data, using a first array of transmission detectors, corresponding to detected fan beam radiation transmitted through the container in said first container position, wherein the container in said first container position is rotated about an axis perpendicular to the fan beam; calculating an effective atomic number and density of the container using said first transmittance scan data; generating an alarm if said at least one item is suspected as threat using at least one of said effective number and density; moving the X-ray source to a second source position to generate radiation; moving the container to a second container position; positioning a second collimator for limiting the radiation, generated by the X-ray source in said second position, to produce a shaped beam that irradiates the container in said second position; detecting scatter scan data, using an array of scatter detectors, corresponding to detected shaped beam radiation scattered from the object in said second position; detecting second transmittance scan data, using a second array of transmission detectors, corresponding to detected attenuated radiation transmitted through the container in said second container position and an attenuator positioned before the second array of transmission detectors, wherein said scatter scan data and said second transmittance scan data are obtained simultaneously; generating a diffraction signature by correcting said scatter scan data using said second transmission scan data; and confirming said at least one item of the container as threat or non-threat by using a combination of said diffraction signature and at least one of said effective atomic number and density.

Optionally, the attenuator is a filter or a scatterer.

Optionally, the method further comprises placing a detector collimator before said array of scatter detectors.

Optionally, the container is rotated, in increments, by a total angle which is at least a sum of a fan angle of the fan beam and 180 degrees to produce a computed-tomographic image. Still optionally, the object is rotated by 360 degrees about the axis perpendicular to the fan beam.

Optionally, the shaped beam is a pencil beam. Still optionally, the shaped beam is a ring or cone shaped beam.

Optionally, the first collimator is positioned at a location determined by generating and analyzing a dual energy radiograph of the container.

The aforementioned and other embodiments of the present specification shall be described in greater depth in the drawings and detailed description provided below.

### BRIEF DESCRIPTION OF THE DRAWINGS

These and other features and advantages of the present specification will be appreciated, as they become better understood by reference to the following detailed description when considered in connection with the accompanying drawings, wherein:

FIG. 1 is a schematic diagram of the scanning system according to one embodiment of the present specification;

FIG. 2A illustrates one embodiment of an XRD (X-ray Diffraction) subsystem, as shown in FIG. 1, and according to the present specification;

FIG. 2B illustrates the XRD subsystem of FIG. 2A further including a filter;

FIG. 2C illustrates XRD subsystem of FIG. 2A, further including a scatterer;

FIG. 3A illustrates another embodiment of an XRD subsystem, as shown in FIG. 1 and according to the present specification;

FIG. 3B illustrates the XRD subsystem of FIG. 3A further including a filter;

FIG. 3C illustrates the XRD subsystem of FIG. 3A further including a scatterer;

FIG. 4A illustrates one embodiment of a point source subsystem with a pencil and fan beam configuration;

FIG. 4B illustrates another embodiment of the point source system of FIG. 4A wherein the point source is moved from a first position to a second position;

FIG. 4C is a flow chart illustrating a plurality of steps of a method of resolving threat using radiographic and XRD inspections;

FIG. 4D is a flow chart illustrating a plurality of steps of another method of resolving threat using radiographic and XRD inspections;

FIG. 5A illustrates the use of moving a source from a first position to a second position to perform either an XRD or CT measurement;

FIG. 5B illustrates the use of a point source and different beam types;

FIG. 5C is a flow chart illustrating a plurality of steps of a method of resolving threat using CT and XRD inspections;

FIG. 5D is a flow chart illustrating a plurality of steps of another method of resolving threat using CT and XRD inspections.

FIG. 6 is an exemplary user interface through which an operator of the system of the present specification can enter data, such as container attributes;

FIG. 7 is a schematic illustration showing how dual energy-CT separates an exemplary set of threat LAGs from exempt LAGs on the basis of where they are located in a density-Z_{eff} space;

FIG. 8 illustrates one embodiment of the system of present specification, wherein bottled liquids/LAGs are inspected using coherent X-ray scatter (CXS) techniques;

FIG. 9 illustrates one embodiment of a combined CT/CXS scanning system for screening LAGs;

FIG. 10 shows a CT scanning configuration for LAGs, according to one embodiment of the present specification;

FIG. 11 shows a CXS scanning configuration for alarm resolution, according to one embodiment of the present specification;

FIG. 12A shows CXS spectra from tests on known LAG threats; and

FIG. 12B shows CXS spectra from a variety of benign LAGs.

### DETAILED DESCRIPTION

The present specification is an improved method of screening LAGS that uses X-ray scanning techniques for the detection of materials of interest. The present specification provides a method for effectively confirming or rejecting alarm conditions presented by primary screening systems, and can accurately detect contraband such as explosives, drugs, chemical weapons, and other materials of interest. Thus, in one embodiment, the present specification describes the use of the coherent X-ray scatter signature, along with Z_{eff} and ρ as determined from radiography or CT, to screen for LAGs.

The system described in the present specification can also be used as a primary inspection system.

In one embodiment, an object is placed in an area of the inspection system of the present specification to determine whether the object contains a material of interest. In another embodiment, an object that generates an alarm in one inspection system is placed in a separate stand-alone system described in the present specification. The stand-alone system then confirms or clears the presence of a material of interest. In one embodiment, the materials of interest include explosives in solid, and in liquid, aerosol and gel (LAG) form, and explosives precursors in a variety of container types including plastic, glass and metallic, transparent or opaque. In one embodiment, the system screens bottled and/or LAGs contained within a bag for the presence of explosive, flammable, or oxidizing materials, and the results are insensitive to the shape and composition of containers of such materials, the presence of external labels, and the fill level.

In one embodiment, the system of present specification uses a combination of X-ray Diffraction (hereinafter referred to as ‘XRD’) and CT imaging technologies to confirm the presence or absence of threat materials. The XRD signature is based on either coherent X-ray scattering, in the case of amorphous materials, or on X-ray diffraction, in the case of polycrystalline or crystalline materials. The CT technology can be based on either single-energy measurements, which produce an estimate of only ρ, or dual energy (DE) or multi-energy (ME) measurements, which produce an estimate of both Z_{eff} and ρ.

In one embodiment, the decision process of confirming the presence of a material comprises performing a fusion of data obtained by using the two technologies. XRD comprises small-angle coherent scatter or X-ray diffraction of the X-ray beam from the object and is sensitive to the chemical structure and composition of most materials. Single energy CT measurements produce an estimate of only the density of the inspected materials, while DE or ME CT imaging provides a measurement of both the Z_{eff} and ρ properties of the inspected materials. Combining the information from both technologies allows accurate identification and classification of most explosives and precursors, and also enables to distinguish them from benign materials.

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention. In the description and claims of the application, each of the words “comprise” “include” and “have”, and forms thereof, are not necessarily limited to members in a list with which the words may be associated.

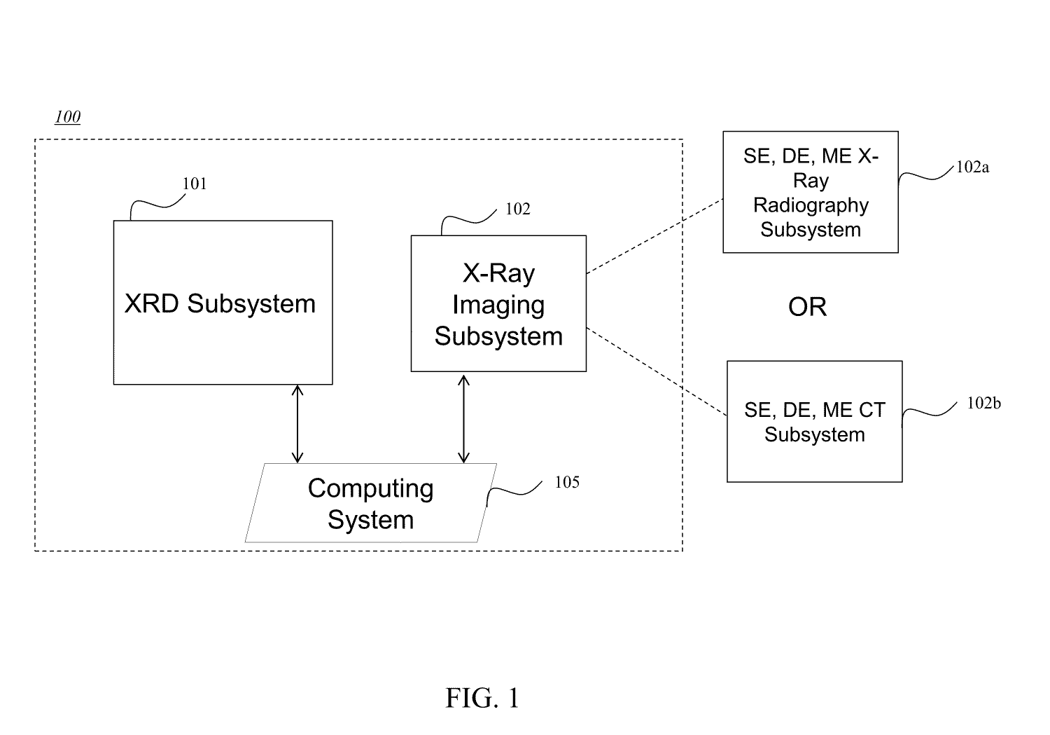

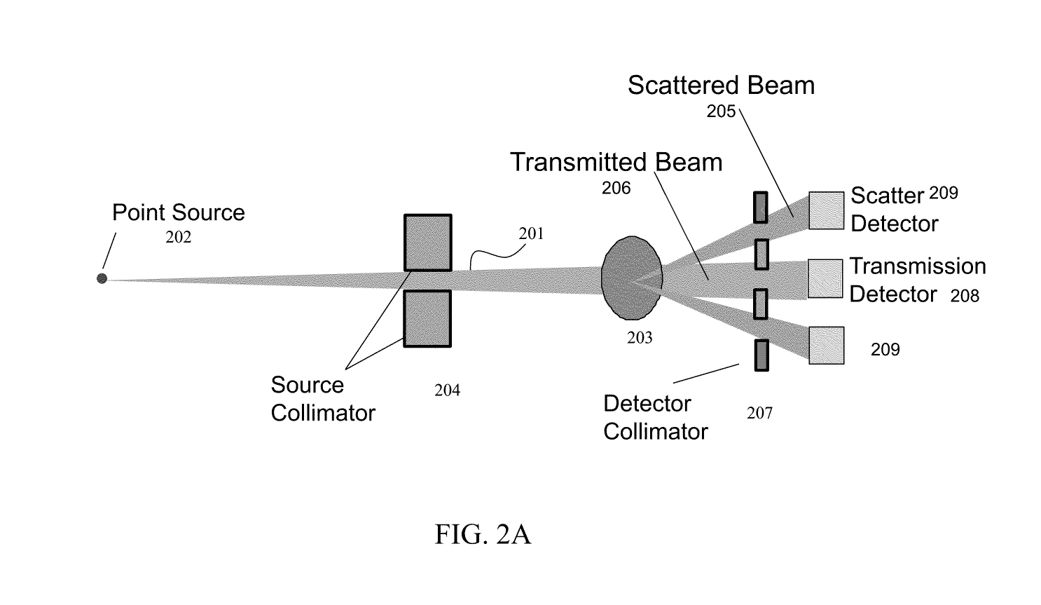

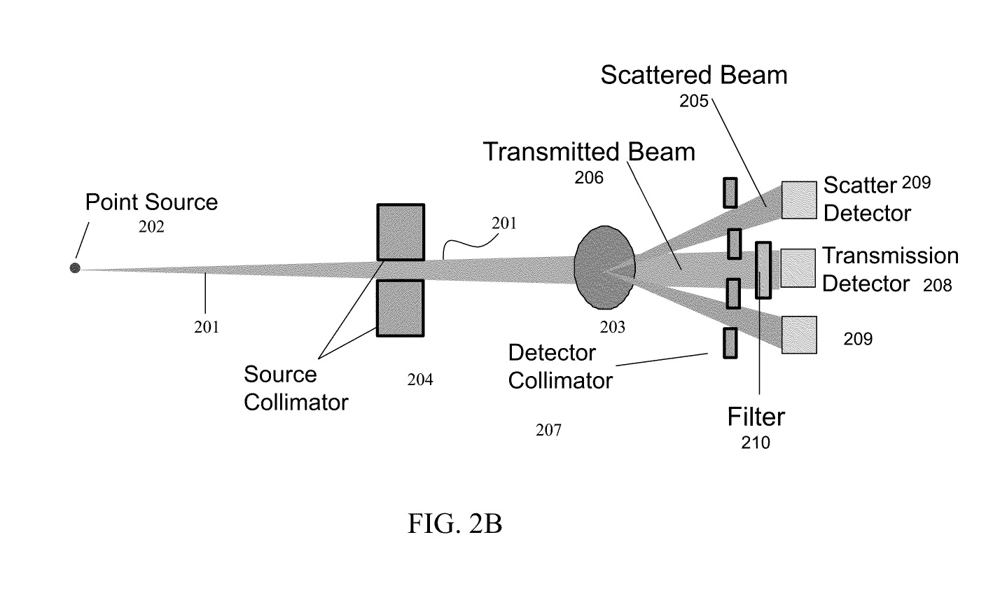

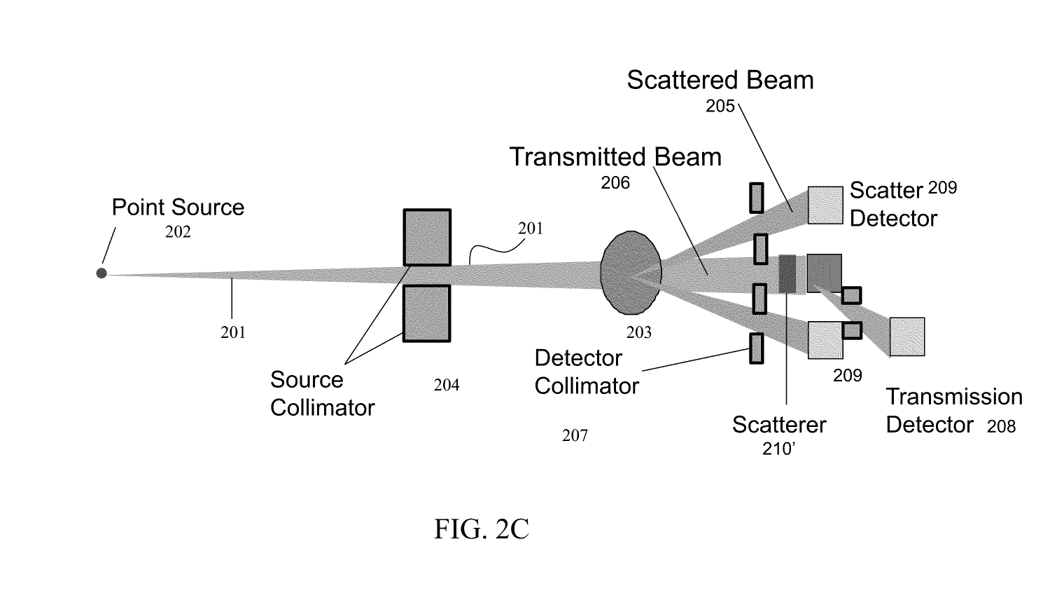

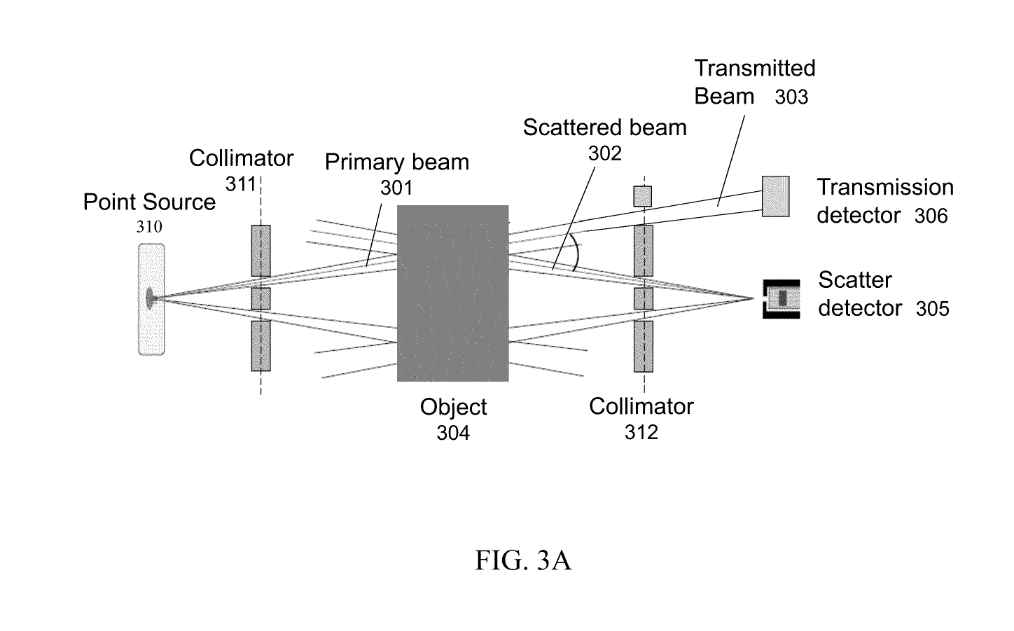

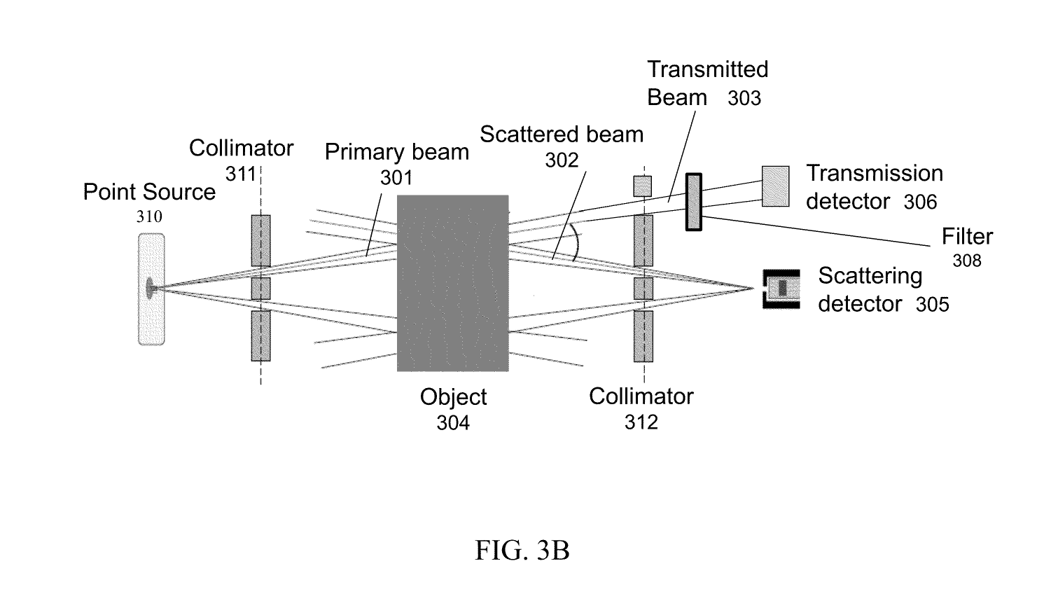

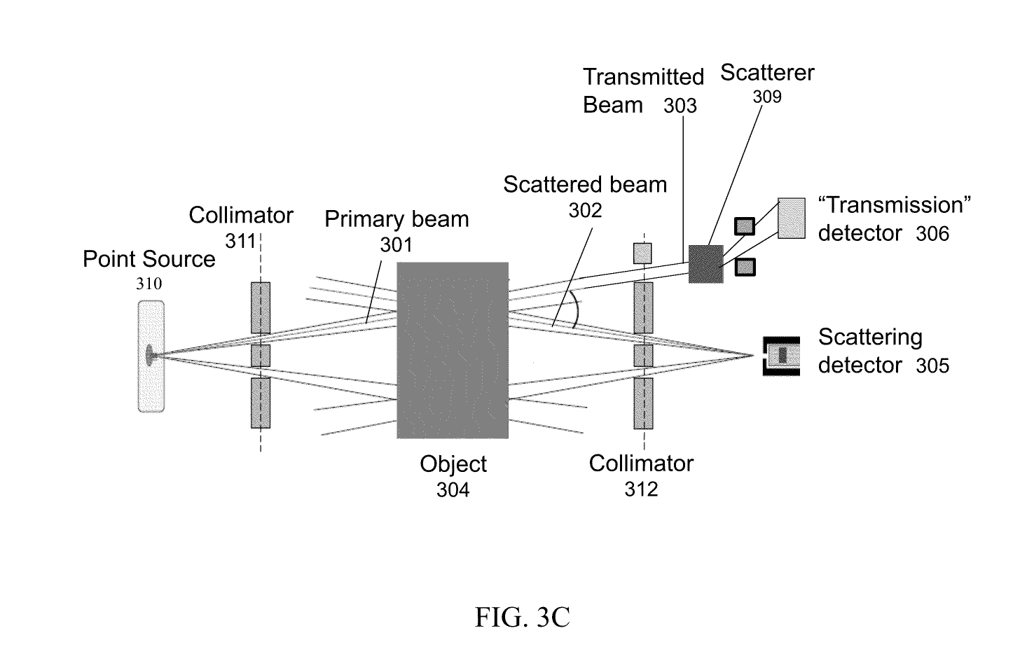

Referring to FIG. 1, in one embodiment of the present specification, the system 100 comprises two subsystems: an XRD subsystem 101 and an X-Ray Imaging subsystem 102. The two subsystems 101, 102 are in communication with at least one computing system 105, comprising required storage and at least one processor as would be evident to persons of ordinary skill in the art. The computing system 105 also comprises necessary software instructions to analyze a plurality of scan data generated by the subsystems 101, 102 in accordance with a plurality of methods of the present invention. The X-Ray Imaging subsystem 102, in some embodiments, may be a single-, dual- or multi-energy (SE, DE, or ME) X-ray radiography system 102a or a single-, dual-, or multi-energy (SE, DE, or ME) computed tomography (CT) imaging system 102b. The X-ray imaging subsystem 102 can be used to produce an image that can be analyzed to determine or identify a location of the object of interest within a container and to determine and use the identified location for subsequent transmittance measurements. Further, the XRD subsystem 101 may be implemented in either of two basic configurations: a pencil beam configuration, shown in FIGS. 2A-2C, or a confocal geometry configuration, shown in FIGS. 3A-3C. In some embodiments, there may also be combination systems in which multiple pencil or confocal geometry beams are deployed in conjunction with a fan beam. The CT imaging system may be implemented with either fan-beam or cone-beam configurations.

The XRD and X-Ray Imaging subsystems 101, 102 use beams formed from a polychromatic X-ray beam. The polychromatic X-ray beam may be produced from a bremsstrahlung X-ray source, that is characteristic of the anode material of the X-ray tube, and that can be optionally filtered to tailor the spectrum to achieve a desired outcome, such as improving the signal-to-noise ratio in a measurement or reducing certain artifacts, in the CT or Radiographic image, such as beam hardening.

The polychromatic X-ray beam originates from a focal spot of the X-ray tube. The focal spot is designated as point source 202 in FIGS. 2A, 2B and 2C and as point source 310 in FIGS. 3A, 3B, and 3C.

Referring to FIGS. 2A through 2C, in one embodiment of a pencil beam configuration of the XRD subsystem, the system employs a source collimator 204 to produce a pencil beam 201 of X-rays from a polychromatic X-ray source 202. The resultant pencil beam 201 is used to irradiate an object under inspection 203 which in turn, results in transmitted beam of radiation 206 and at least one scattered beam of radiation 205. The dimensions and the angle of scatter from the object 203, along with the dimensions of the transmitted pencil beam 206 reaching transmission detector 208 are determined by detector collimator 207. The dimensions of the scattered beam collimator determine the location of the origin of the scatter from the object 203 as well as the energy resolution of the measurement. Energy resolving spectroscopic detectors are used to measure the spectrum of the transmitted radiation 206 at transmission detector 208 and the spectrum of the scattered radiation 205 at scatter detector(s) 209. The scatter detector(s) 209 may be deployed in a variety of geometries. For example, the scatter detector(s) 209 may range from a single detector, to multiple detectors, to a ring of segmented detectors deployed in the ring of scattered radiation. In various embodiments, a filter 210 is used between the transmitted radiation 206 and transmission detector 208 as shown in FIG. 2B. In still further embodiments, a scatterer 210′ is used between the transmitted radiation 206 and transmission detector 208 as shown in FIG. 2C. Use of the attenuating filter 210 or the scatterer 210′ reduces the intensity of the beam 206. In some embodiments, a pinhole is used to reduce the intensity of the beam 206.

Referring to FIGS. 3A through 3C, in one embodiment of a confocal geometry XRD subsystem, the system employs a collimator 311 to produce a beam 301 from a polychromatic X-ray source 310. The beam 301 is in the form of a ring or cone which irradiates an object 304. From the object 304, the radiation is scattered and a second collimator 312 collimates the at least one resultant scattered beam 302 onto a “point” detector 305. The resultant transmitted beam 303, which has a pencil beam shape, is employed to measure the transmittance of the object 304 along the same approximate path as the scatter radiation 302 using transmission/spectroscopic detector 306.

Diffracted and coherently scattered X-ray photons only undergo a change in the direction of propagation and not a change in energy after interacting with the object under inspection 304. The resulting X-ray signal measured by detector 305 contains the spectral distribution of the original polychromatic X-ray beam 301 modified by other interactions, such as Compton scatter and photoelectric absorption, with the object 304 and its surrounding materials. These other interactions change the energy of the X-ray and will lead to spectral artifacts in the measured scatter spectra. As discussed in U.S. Pat. No. 7,417,440, the transmission spectra are used to correct the scatter spectra for the effects introduced by the spectral distribution of the original polychromatic X-ray beam 301, as well as by spectrum-distorting effects such as beam hardening. The transmission spectra can be measured with an energy-dispersive detector or approximated with a dual-energy stacked detector configuration and a lookup table. This correction is implemented by dividing the measured scattered spectra by measured transmission spectra.

The normalized scatter spectra contain two types of information. First, coherent X-ray scatter (CXS) and X-ray diffraction (XRD) will produce peaks and valleys in the normalized spectra whose location in energy is related to the characteristic molecular structure of the object under examination 304. It is this signature that is used to classify LAGs and other threats. Second, the average intensity of the normalized scatter signal is linearly related to the gravimetric density of the object under inspection 304.

It is known in the art that use of high intensity beam for transmission spectroscopy has a detrimental effect on the performance of the detector being used. For example, pulse pileup effects will cause the high-energy portion of the measured spectra to be distorted as two or more lower-energy X-ray photons are counted as a high-energy X-ray photon. Additionally, dead time effects will cause the detector response to be non-linear with intensity. These effects will distort the normalized scatter spectrum and therefore, the system of present invention employs four approaches to reduce the deleterious effects associated with the high-intensity transmittance beam on the spectroscopic detector.

In one embodiment, an energy-dispersive detector with specialized detector electronics that can collect X-ray spectra at several million counts per second can be used to measure the scatter spectra. These detectors are commercially available from Multix SA, for example.

In a second embodiment, a pinhole is used to reduce the X-ray flux incident on the transmission detector.

In a third embodiment, as shown in FIG. 3B, a filter 308 fabricated from a material with a low atomic number is used to reduce the flux incident upon the transmission detector 306.

In a fourth embodiment, the beam is Compton-scattered to the transmission detector placed outside the beam and the resulting measured spectrum is corrected to determine the transmitted spectrum. Accordingly, a scatterer 309 is placed between the transmitted beam 303 and the transmission detector 306, as shown in FIG. 3C.

In both the third and fourth embodiments, the measured spectral shape is corrected to recover the primary beam spectrum.

Unlike conventional digital radiography (DR), the present embodiments may not use a first stage scan as a means of determining a location for additional inspection. Rather, in some embodiments, the system is used to generate physical attributes of the liquid article under examination that are used for classification. For example, dual-energy CT is used to determine the Z_{eff} and ρ of the article under inspection that is then used for classification.

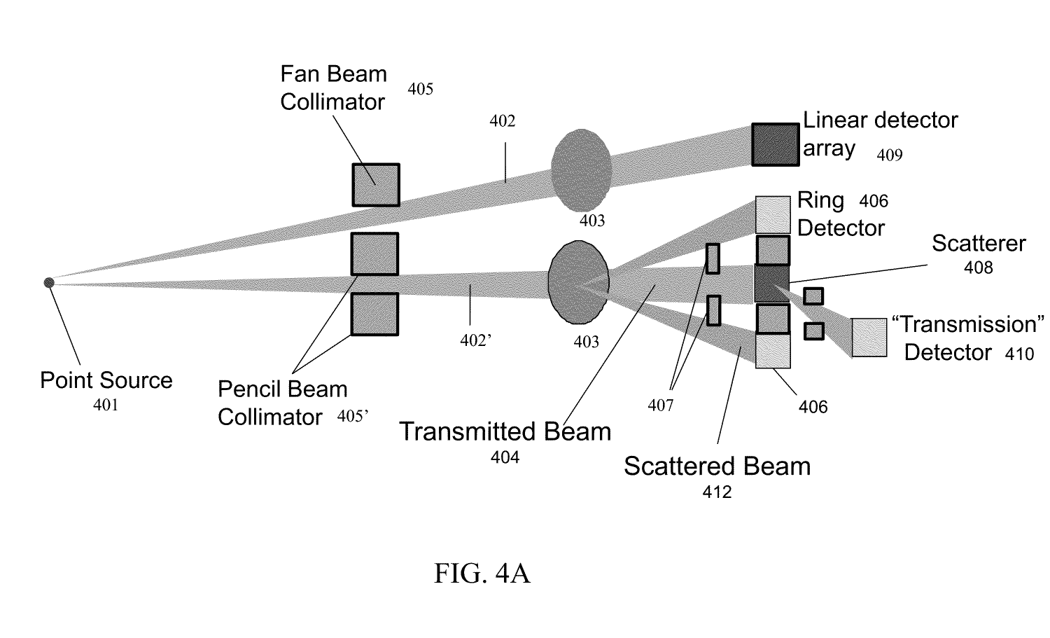

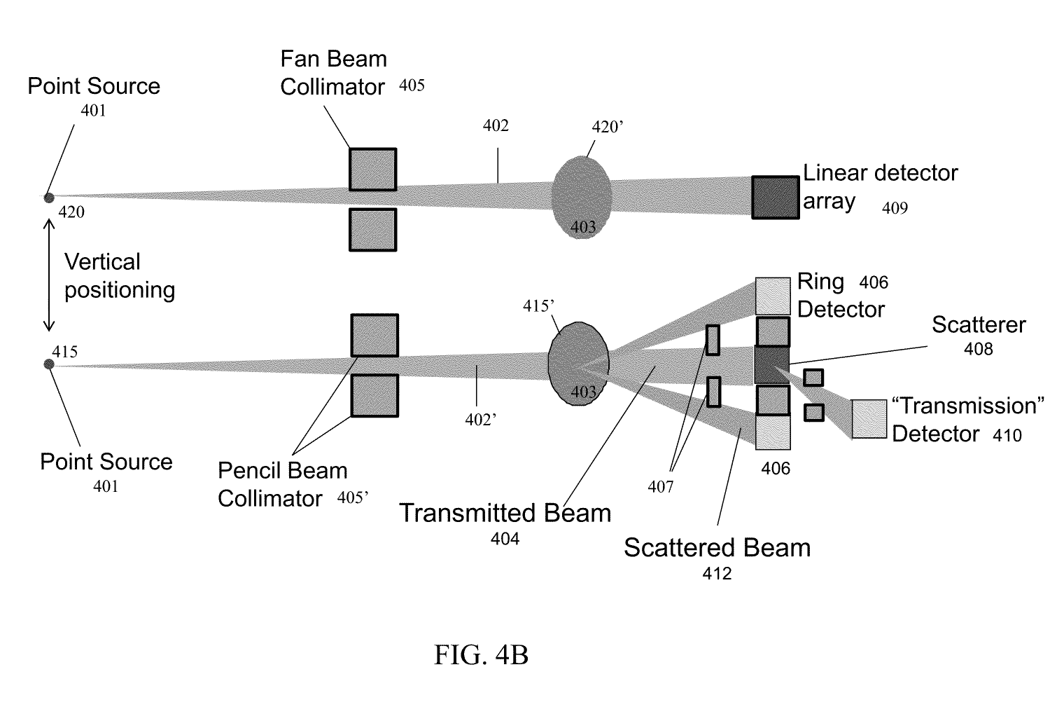

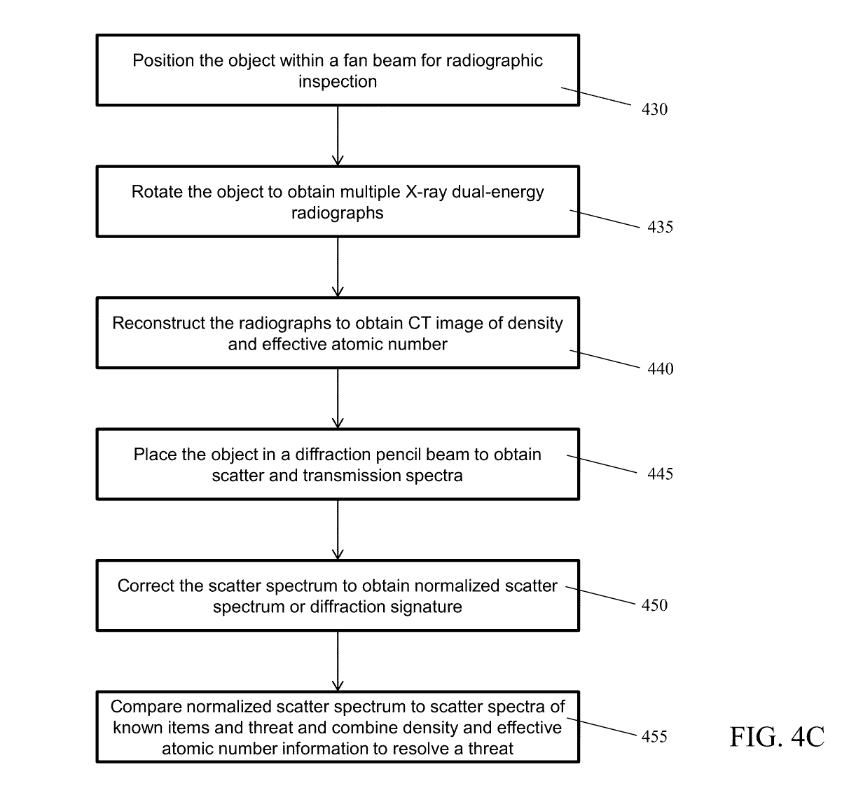

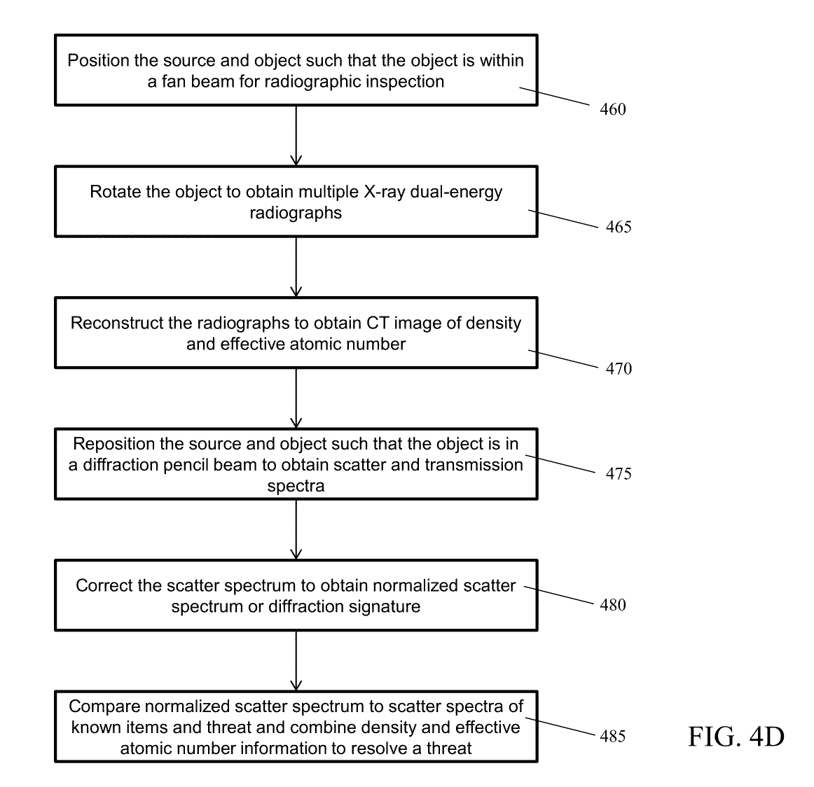

As shown in FIGS. 4A and 4B, in one embodiment, radiographic and XRD inspections of an object 403 are performed with a shared point source 401 while differing source collimators 405 and 405′ are respectively used for each inspection. Referring to FIG. 4A, when deploying an X-ray Imaging Subsystem, embodied as an X-ray radiography system, a fan beam of X-ray radiation 402, formed by a fan beam collimator 405, is employed. An array of detectors 409, which in one embodiment are dual-energy stacked detectors, deployed in a straight line or an arc along the fan-beam 402 are employed to detect the radiation transmitted through the object 403 to produce an image of a single slice or multiple slices through the object 403.

Referring again to FIG. 4A, when deploying an XRD Subsystem in pencil beam configuration, beam from source 401 is passed through pencil beam collimators 405′ to obtain the desired pencil beam 402′. While the fan beam 402 that produces a transmittance map across one slice of the object 403 is detected by the linear detector array 409, the pencil beam 402′ is scattered by the object 403 and subsequently the scattered radiation 412 is detected by the ring detectors 406 (that are energy sensitive/energy resolving spectroscopic detectors, in accordance with an embodiment). Appropriate detector collimators 407 are placed before the ring detectors 406. A portion 404 of the pencil beam 402′ is also transmitted through the object 403. This transmitted beam 404 is made to hit an attenuating filter (such as filer 210 of FIG. 2B or filter 308 in FIG. 3B), a scatterer 408 (similar to the scatterer 210′ of FIG. 2B or scatterer 309 of FIG. 3C) or a pinhole which reduces the intensity of the beam 404. The attenuated transmitted beam is then detected by the transmission detector 410, and used to correct the detected scatter spectrum 412 to obtain normalized scatter spectrum.

Referring now to FIG. 4B, in a second embodiment of the X-ray imaging subsystem, embodied as an X-ray radiography system, source 401 is translated from a first position 415 (for performing XRD inspection) to a second position 420 (for performing radiographic inspection) where a fan beam collimator 405 shapes a beam into a fan 402 parallel to a pencil beam 402′ used for XRD, as shown in FIG. 4A. Similarly, the object 403 is also moved from a first object location 415′ to a second object location 420′. It should be appreciated that the source (and similarly the object 403) is moved from the first position 415 to the second position 420 once the XRD inspection and the related analysis are complete. An array of detectors 409, deployed in a straight line or arc along the fan-beam 402 is employed to detect the radiation transmitted through the object 403 to produce a single projection view of a slice of the object 403. Multiple projection views of the object 403, used to reconstruct a CT image, are obtained by rotating the object 403 (by 180 degree+fan angle) about an axis perpendicular to the X-ray fan beam 402 relative to the array of detectors 409. In some embodiments, the object 403 is rotated, in increments, by a total angle which is at least a sum of a fan angle of the X-ray fan beam 402 and 180 degrees to produce a computed-tomographic image. Persons of ordinary skill in the art should note that the sequence of performing radiographic and XRD inspections may vary in either embodiments of FIGS. 4A and 4B. In other words, the XRD inspection may be followed by the radiographic inspection and vice versa. Still further, if the object 403 is successfully classified as a benign or a threat during a first inspection, using either radiography or XRD, then a second inspection is not required.

FIG. 4C is a flow chart showing a plurality of exemplary steps of a method of resolving threat in accordance with an embodiment. Referring now to FIGS. 4A and 4C, at step 430, the object 403 is positioned within the fan beam 402 for performing radiographic inspection. At step 435, multiple X-ray dual-energy radiographs are obtained by rotating the object 403 about an axis perpendicular to the fan beam 402 relative to the detectors 409. In some embodiments, the object 403 is rotated, in increments, by a total angle which is at least a sum of a fan angle of the X-ray fan beam 402 and 180 degrees to produce a computed-tomographic image. Thereafter, the radiographs are reconstructed, at step 440, to form a computed tomographic image of the density (ρ) and effective atomic number (Z_{eff}) of the objects. Next, at step 445, the object 403 is placed in the diffraction pencil beam 402′ to obtain X-ray scatter spectrum from the object 403 and transmission spectrum through the object 403. At step 450, the transmission spectrum is used to correct the scatter spectrum and obtain normalized/corrected scatter spectrum or diffraction signature. Finally, at step 455, the normalized/corrected scatter spectrum is compared to a set of scatter spectra from threats and benign items and this information, along with the measured density (ρ) and effective atomic number (Z_{eff}) of step 440, is used to identify the object as either a threat or alarm. It should be appreciated that the scan sequence may change. For example, the density and effective atomic number produced by the radiographic inspection may be sufficient to classify the object as a benign or threat. Additionally, the diffraction/XRD examination may be performed before the radiographic examination and the measured X-ray spectrum may be sufficient to classify or resolve the object as a benign or alarm.

FIG. 4D is a flow chart showing a plurality of exemplary steps of a method of resolving threat in accordance with another embodiment. Referring now to FIGS. 4B and 4D, at step 460, the source 401 is placed in the first position 420 and the object 403 is also placed in the first object location 420′, within the fan beam 402, for performing radiographic inspection. At step 465, multiple X-ray dual-energy radiographs are obtained by rotating the object 403 about an axis perpendicular to the fan beam 402 relative to the detectors 409. In some embodiments, the object 403 is rotated, in increments, by a total angle which is at least a sum of a fan angle of the X-ray fan beam 402 and 180 degrees to produce a computed-tomographic image. Thereafter, the radiographs are reconstructed, at step 470, to form a computed tomographic image of the density (ρ) and effective atomic number (Z_{eff}) of the objects. Next, at step 475, the source 401 is moved to the second position 415 and the object 403 is also moved to the second object location 415′ within the diffraction pencil beam 402′ to obtain X-ray scatter spectrum from the object 403 and transmission spectrum through the object 403. At step 480, the transmission spectrum is used to correct the scatter spectrum and obtain normalized/corrected scatter spectrum. Finally, at step 485, the normalized/corrected scatter spectrum is compared to a set of scatter spectra from threats and benign items and this information, along with the measured density (ρ) and effective atomic number (Z_{eff}) of step 470, is used to identify the object as either a threat or alarm. It should be appreciated that the scan sequence may change. For example, the density and effective atomic number produced by the radiographic inspection may be sufficient to classify the object as a benign or threat. Additionally, the diffraction/XRD examination may be performed before the radiographic examination and the measured X-ray spectrum may be sufficient to classify or resolve the object as a benign or alarm.

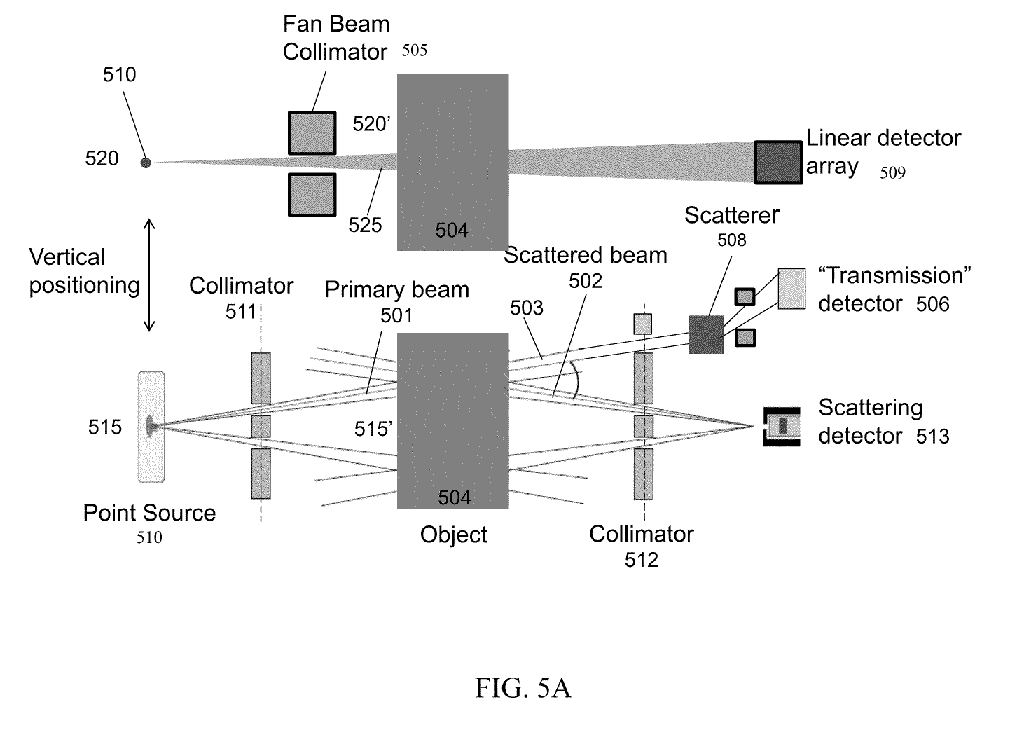

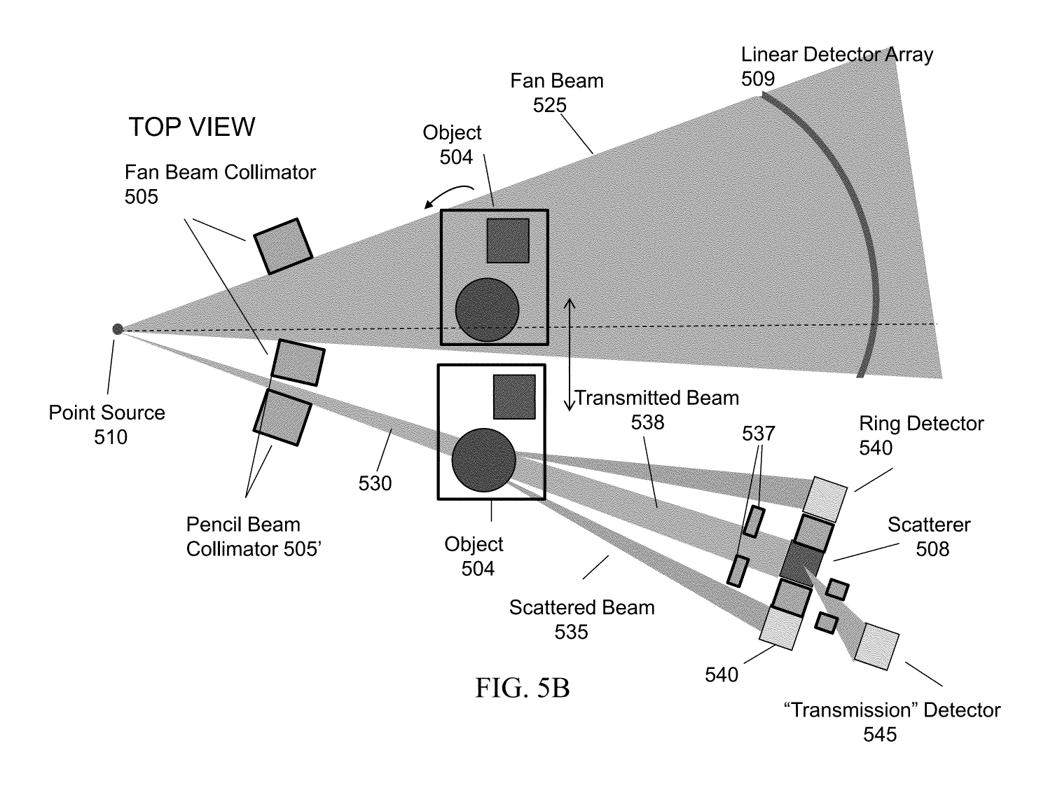

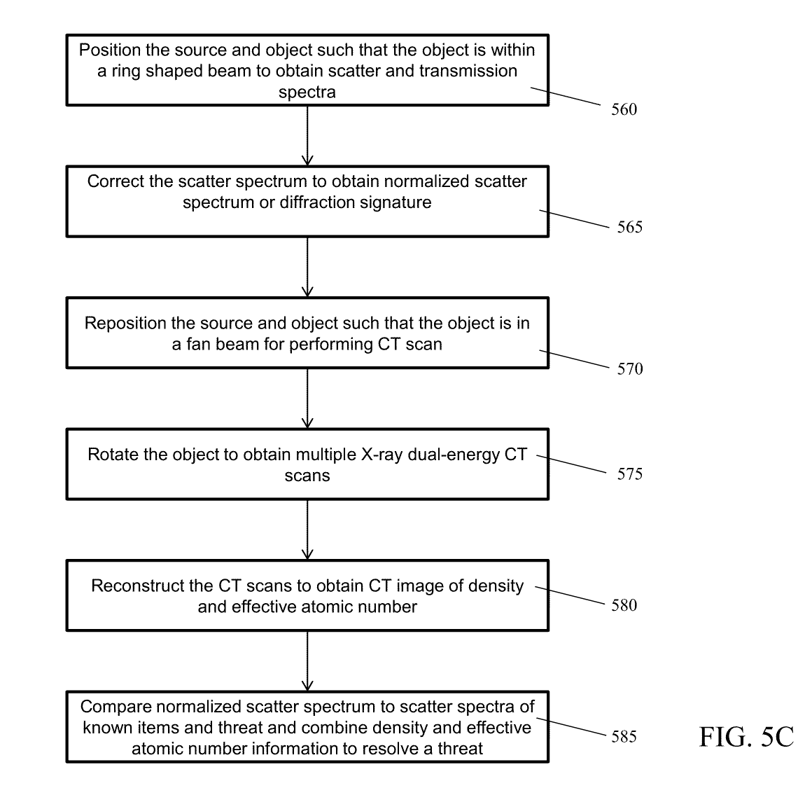

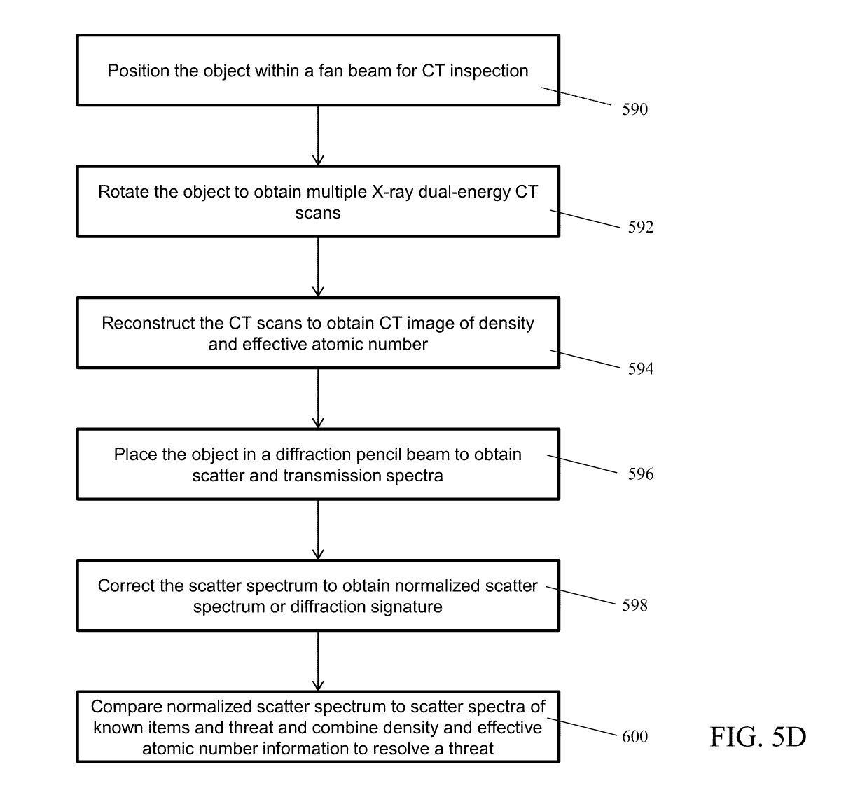

FIGS. 5A and 5B illustrate CT and XRD inspections of an object 504, in accordance with another embodiment. Referring now to FIG. 5A, in one embodiment, the X-ray Imaging Subsystem is embodied as a CT scan system while the XRD Subsystem is embodied in a confocal configuration. In the confocal configuration of the XRD Subsystem, a collimator 511 produces a beam 501 from a polychromatic source 510 at a first position 515. The beam 501 is in the form of a ring or a cone which irradiates the object 504 placed at a first object location 515′. From the object 504, the radiation is scattered and a second collimator 512 collimates the at least one resultant scattered beam 502 onto a “point” detector 513. The resultant transmitted beam 503, which has a pencil beam shape, is employed to measure the transmittance of the object 504 along the same approximate path as the scatter radiation 502 using transmission/spectroscopic detector 506. In one embodiment, a scatterer 508 (a pinhole or a filter, such as filter 308 of FIG. 3B) is deployed before the transmitted beam 503 hits the transmission detector 506. A CT scan is achieved by moving the X-ray source 510 to a second position 520 where a fan beam collimator 505 shapes the beam into a fan. Similarly, the object 504 is also moved from a first object location 515′ to a second object location 520′. It should be appreciated that the source (and similarly the object 504) is moved from the first position 515 to the second position 520 once the XRD inspection and the related analysis are complete. An array of detectors 509, deployed in a straight line or arc along the fan-beam 525 is employed to detect the radiation transmitted through the object 504 (in the second object location 520′) to produce a single projection view of a slice of the object 504. Multiple views of the object 504, used to reconstruct a CT image, are achieved by rotating the object 504 (by 360 degrees) about an axis perpendicular to the X-ray fan beam 525 relative to the detectors 509. In some embodiments, the object 504 is rotated, in increments, by a total angle which is at least a sum of a fan angle of the X-ray fan beam 525 and 180 degrees to produce a computed-tomographic image.

Referring now to FIG. 5B, in another embodiment, the X-ray Imaging Subsystem is embodied as a CT scan system using a fan beam while the XRD Subsystem is embodied in a pencil beam configuration. The object 504 is moved to position in either the pencil beam or in the fan beam. In one embodiment, a first inspection of the object 504 is a CT scan which is followed by a second inspection using the XRD subsystem. In another embodiment, the first inspection of the object is an XRD scan which is followed by a second inspection using the CT scan system. In still further embodiments, the object 504 is subjected to only one inspection which may be either the CT scan or an XRD scan. The X-ray Imaging Subsystem, embodied as a CT scan system, employs a fan beam of X-ray radiation 525 (of the polychromatic source 510), formed by a fan beam collimator 505. An array of detectors 509, deployed in a straight line or an arc along the fan-beam 525 is employed to detect the radiation transmitted through the object 504 to produce an image of a single slice or multiple slices through the object 504. Multiple projection views of the object 504, used to reconstruct a CT image, are obtained by rotating the object 504 (by 360 degrees) about an axis perpendicular to the X-ray fan beam 525 relative to the detectors 509.

In some embodiments, the object 504 is rotated, in increments, by a total angle which is at least a sum of a fan angle of the X-ray fan beam 525 and 180 degrees to produce a computed-tomographic image. In an XRD Subsystem in pencil beam configuration, a beam from the source 510 is passed through pencil beam collimators 505′ to obtain the desired pencil beam 530. While the fan beam 525 that produces a transmittance map across one slice of the object 504 is detected by the linear detector array 509, the pencil beam 530 is scattered by the object 504 and subsequently the scattered radiation 535 is detected by the ring detectors 540. Appropriate detector collimators 537 are placed before the ring detectors 540. A portion 538 of the pencil beam 530 is also transmitted through the object 504. This transmitted beam 538 is made to hit an attenuating filter (such as filer 210 of FIG. 2B or filter 308 in FIG. 3BA), a pinhole or a scatterer 508 (similar to the scatterer 210′ of FIG. 2B or scatterer 309 of FIG. 3C) which reduces the intensity of the beam 538. The attenuated transmitted beam is then detected by the transmission detector 545, and used to correct the detected scatter spectrum 535 to obtain normalized scatter spectrum. Persons of ordinary skill in the art should note that the sequence of performing CT and XRD inspections may vary in either embodiments of FIGS. 5A and 5B. In other words, the XRD inspection may be followed by the CT inspection and vice versa. Still further, if the object 504 is successfully classified as a benign or a threat during a first inspection, using either CT or XRD, then a second inspection is not required.

FIG. 5C is a flow chart showing a plurality of exemplary steps of a method of resolving threat in accordance with an embodiment. Referring now to FIGS. 5C and 5A, at step 560, the source 510 is placed in the first position 515 and the object 504 is also placed in the first object location 515′ within the diffraction ring or cone shaped beam 501 to obtain X-ray scatter spectrum from the object 504 and transmission spectrum through the object 504. At step 565, the transmission spectrum is used to correct the scatter spectrum and obtain normalized/corrected scatter spectrum. Next, at step 570, the source 510 is moved to the second position 520 and the object 504 is also placed in the second object location 520′ within the fan beam 525 for performing CT inspection. At step 575, multiple X-ray dual-energy CT scans are obtained by rotating the object 504 (by 360 degrees) about an axis perpendicular to the fan beam 402 relative to the detectors 509. In some embodiments, the object 504 is rotated, in increments, by a total angle which is at least a sum of a fan angle of the X-ray fan beam 402 and 180 degrees to produce a computed-tomographic image. Thereafter, the CT scans are reconstructed, at step 580, to form a computed tomographic image of the density (ρ) and effective atomic number (Z_{eff}) of the objects. Finally, at step 585, the normalized/corrected scatter spectrum or diffraction signature is compared to a set of scatter spectra or diffraction signatures from threats and benign items and this information, along with the measured density (ρ) and effective atomic number (Z_{eff}) of step 580, is used to identify the object as either a threat or alarm. It should be appreciated that the scan sequence may change. For example, the normalized/corrected scatter spectrum or diffraction signatures produced by the XRD inspection may be sufficient to classify the object as a benign or threat. Additionally, the CT examination may be performed before the diffraction/XRD examination and the measured density (ρ) and effective atomic number (Z_{eff}) may be sufficient to classify or resolve the object as a benign or alarm.

FIG. 5D is a flow chart showing a plurality of exemplary steps of a method of resolving threat in accordance with another embodiment. Referring now to FIGS. 5D and 5B, at step 590, the object 504 is positioned within the fan beam 525 for performing CT inspection. At step 592, multiple X-ray dual-energy CT scans are obtained by rotating the object 504 (by 360 degrees) about an axis perpendicular to the fan beam 525 relative to the detectors 509. In some embodiments, the object 504 is rotated, in increments, by a total angle which is at least a sum of a fan angle of the X-ray fan beam 525 and 180 degrees to produce a computed-tomographic image. Thereafter, the CT scans are reconstructed, at step 594, to form a computed tomographic image of the density (ρ) and effective atomic number (Z_{eff}) of the objects. Next, at step 596, the object 504 is moved to be placed in the diffraction pencil beam 530 to obtain X-ray scatter spectrum from the object 504 and transmission spectrum through the object 504. At step 598, the transmission spectrum is used to correct the scatter spectrum and obtain normalized/corrected scatter spectrum. Finally, at step 600, the normalized/corrected scatter spectrum is compared to a set of scatter spectra from threats and benign items and this information, along with the measured density (ρ) and effective atomic number (Z_{eff}) of step 594, is used to identify the object as either a threat or alarm. It should be appreciated that the scan sequence may change. For example, the density and effective atomic number produced by the CT inspection may be sufficient to classify the object as a benign or threat. Additionally, the diffraction/XRD examination may be performed before the CT examination and the measured X-ray spectrum or diffraction signature may be sufficient to classify or resolve the object as a benign or alarm.

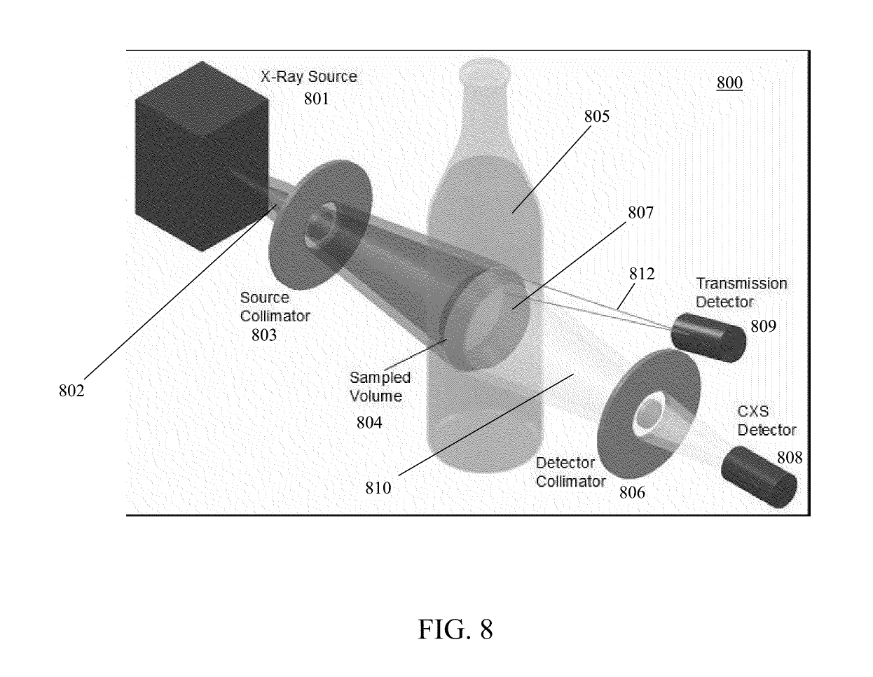

While the above approaches (as described in FIGS. 4A, 4B and 5B) of reducing the detrimental effects of high intensity radiation on transmission detectors have been described with regard to pencil beam configuration of the XRD system, it may be noted that both the approaches are equally applicable to the confocal configuration as well, as described in greater detail below with respect FIG. 8.

As described earlier, with reference to FIG. 1, the scanning system of the present invention comprises two subsystems—the XRD subsystem 101 and the X-ray Imaging Subsystem 102, which is embodied as a CT imaging subsystem in accordance with an embodiment. In some embodiments, the CT imaging subsystem further comprises at least one of the following to obtain the image: 1) an array of stacked detectors; 2) an array of energy-dispersive detectors (e.g. CdTe or CZT, or a fast scintillation detector with a fast solid-state read-out system); 3) a fast or slow-switching high-voltage X-ray tube; or 4) transmission filters or layered synthetic multilayer energy-specific reflective filters to define the spectral regions. The information yielded by the multi-energy CT system is combined in various ways to obtain the properties, that is Z_{eff} and ρ of the material. Additionally, the transmittance information measured by the X-ray Imaging Subsystem may be used to obtain the density of the object. Further, the presence of a material of interest may be determined by employing any combination of techniques, such as the combination of XRD and CT-based Z-determination, XRD and CT-based density determination, or combining XRD, Z_{eff} and ρ information.

In one embodiment, to improve the accuracy of determination of Z and densities of the materials of interest, a top digital camera may be employed in the scanning system to determine the shape of the object being scanned. If the object is not circular; it may be optionally rotated by one or more angles to determine details about the object shape. This information can be used to correct for the shape of the object and/or the attenuation of the container, thus permitting a better estimate of the properties, that is, Z_{eff} and ρ of materials. In one embodiment, the CT detectors have a spatial resolution adequate for imaging of the container and its walls and therefore, obtain an improved correction for container materials and thickness that can be applied to the measurement of the Z_{eff} and ρ of the object under inspection.

In another embodiment, a reference material is used to correct for the effects of absorption and container shape, while screening an object for materials of interest. An example of a reference material that may be used is water, which is a common benign liquid. The transmission and coherent scatter through this reference material—water, is used in the subsequent analysis to correct for the effects of absorption of the object under examination.

In another embodiment, the system of the present specification interfaces with another X-ray scanning system which will provide other properties such as Z_{eff} and/or p. This information may then be combined with the results of the system of the present specification to arrive at a decision confirming the presence or absence of an object.

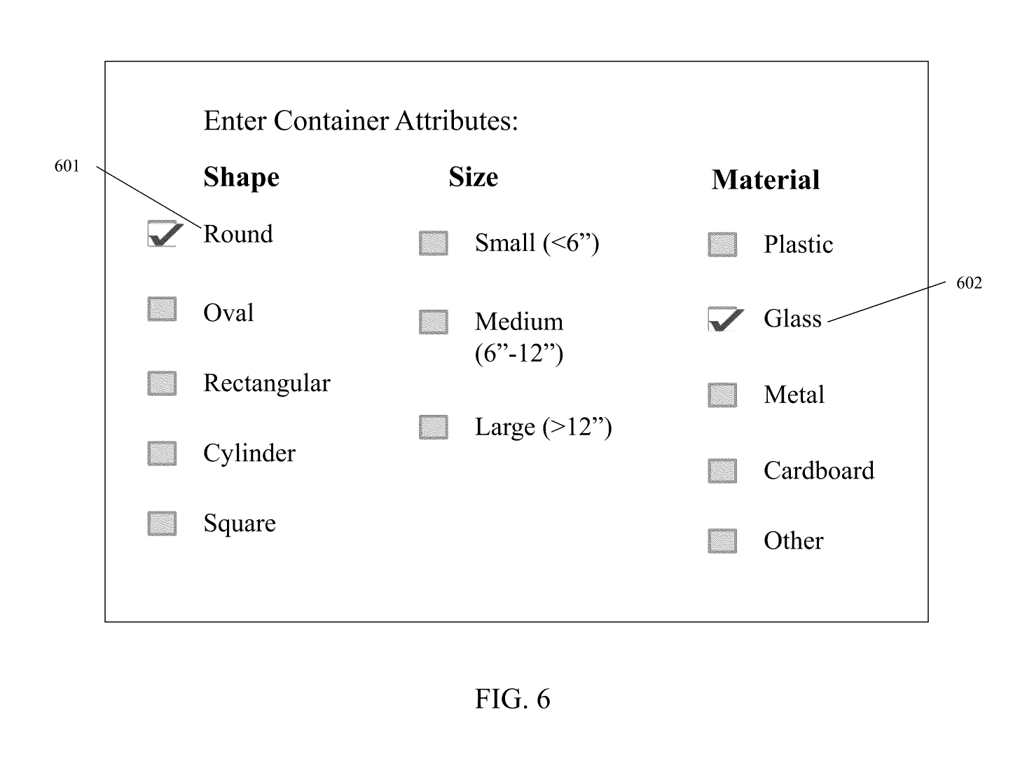

In yet another embodiment, the inspection process may be expedited by having an operator to enter information regarding the shape, material or other attributes of the object or container under inspection. In one embodiment, the information may be entered by the operator using a simple interface, such as a series of checkboxes, as shown in FIG. 6. Referring to FIG. 6, if, for example, the operator selects “round” container 601, the system assumes a round bottle. Similarly, if the operator selects “glass” container 602, the system employs an appropriate algorithm to correct for glass attenuation. In one embodiment, the system stops collecting data from the operator based on a preset time or when sufficient statistics are collected to provide a specified accuracy.

In one embodiment, the present invention uses dual-energy computed tomography and CXS (Coherent X-ray Scatter), within a single system of compact form factor for efficient and effective screening of LAGs. The system is used to automatically identify and distinguish explosive and flammable liquids (pure or mixed with fuel) from benign liquids, such as drinks, lotions, hygiene products, among other compositions. Further, the system maintains detection capability during collective analysis of liquids contained within a single bag, such as a zip-top plastic bag, commonly used by passengers for packing liquids for air travel.

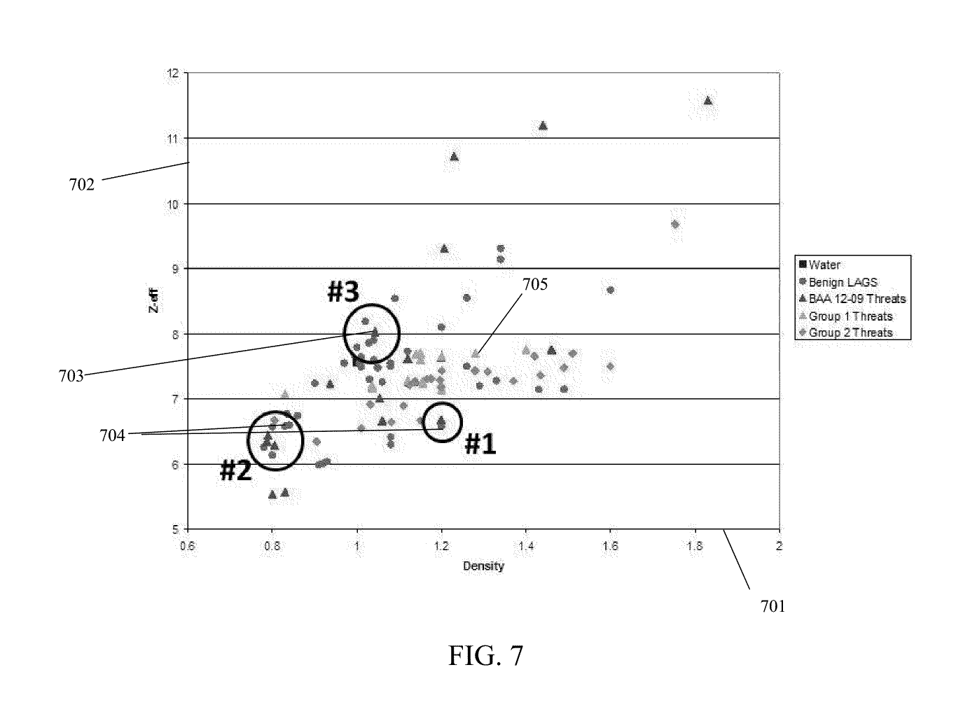

FIG. 7 illustrates how dual energy-CT separates an exemplary set of threat liquids from exempt liquids on the basis of where they are located in density-Z_{eff} space, with density of materials plotted on the X-axis 701 and Z_{eff} plotted on the Y-axis 702. While LAG threats, such as Nitroglycerine, are represented by red diamonds 703, benign and exempt liquids such as water, wine and beer are represented by blue and green triangles 704, 705 respectively.

In one embodiment, the system of the present invention employs dual-energy scanning to obtain Z_{eff}. Dual energy capability is achieved either by switching the voltage of the X-ray tube between low energy (˜100 kV) and high energy (˜160 kV) in one embodiment, or by employing stacked low- and high-energy detectors.

In another embodiment, the system employs multi-energy (ME) CT. The ME detectors operate in a direct conversion mode, where transmitted X-ray photons are directly detected by a semiconductor crystal such as CdTe or CdZnTe. In standard dual energy imaging systems, two broad energy bands are measured with a stack of detectors consisting of a thin scintillator that is separated from a thicker scintillator by a metallic filter. The thin scintillator measures the “Low-Energy” signal while the thick scintillator measures the “High-Energy” signal. The ME approach can achieve a more accurate and precise estimate of Z_{eff} and ρ over standard dual energy detectors.

Dual energy CT can provide a measurement of the Z_{eff} and density that is sufficiently accurate for the detection of explosives among the contents of baggage. Liquid threats, however, have a narrower range of Z_{eff} values and densities that may overlap with some benign liquids, leading to false alarms. FIG. 7 shows the theoretical density-Z_{eff} plots for the common LAG threats, along with plots for a wide range of benign liquids. Most liquids carried by passengers are likely to be clustered near water whose density, ρ=1 g/cm3 and Z_{eff}=7.57. However, some liquids can overlap with LAG threats in density-Z_{eff} space. For these liquids, dual energy-CT is likely to generate an alarm that requires resolution by another scanning technique such as CXS, or by visual inspection by the security officer. Examples of overlaps between the listed threats and benign liquids are highlighted in FIG. 7 by numbered circular regions #1, #2 and #3.

Thus, in some situations CT scanning alone may not differentiate certain threats from benign LAGs. For this reason, the present invention further uses CXS to provide material-discriminating screening that will resolve some of these overlaps. It would be appreciated that CXS is used to characterize the structure of crystalline, polycrystalline, powdered, and amorphous materials. LAGs are amorphous materials with a short-range structural order over several molecules, and thus they produce broad diffraction peaks characteristic of the liquid. For example, combustible liquids and hydrocarbons can be identified by the presence of the coherent scatter feature associated with the carbon-carbon bond. The CXS technique is based on observing the intensity of scatter, as a function of scatter angle or energy.

FIG. 8 illustrates one embodiment of the system 800 of present invention, wherein bottled liquids are inspected using coherent X-ray scatter (CXS) techniques. In one embodiment, the system 800 adopts an energy-dispersive approach, wherein the observation angle is fixed and the energy spectrum of the scattered radiation is measured.

Referring to FIG. 8, the CXS configuration used is known as confocal geometry. Here, an X-ray source 801 produces an annular beam of radiation 802. A source collimator 803 limits the beam to a section 804 of the LAG container 805. A detector collimator 806 is also provided, which confines the measured scatter to a volumetric ring 807 located at the center of the container 805. The scatter signal 810 is measured with an energy-dispersive detector 808, and the transmitted (undeflected) beam 812 is measured with a transmission detector 809. The choice of the source and detector collimators, the distance to the X-ray focal spot, and the distance to the detector are used to determine the effective scatter angle. It is preferred to have the effective scatter angle between 1 and 10 degrees. In this embodiment of the system 800, the path length of the scattered and transmitted X-ray beams is almost the same.

Advantages of confocal geometry for XRD include high brightness, allowing for obtaining the scatter signal from a larger volume of the object defined by the volumetric ring created by the source and detector collimators. Additionally, the scatter signal can be measured with a small, simple and less expensive energy-sensitive detector with an entrance aperture in the shape of a small hole. Room-temperature energy-dispersive detectors comprised of CdTe or CZT have an energy resolution that is well matched to the spectral resolution achieved by the confocal beam geometry.

The transmitted beam data is used to determine the energy-dependent attenuation of the container and liquid. Thus, the shape of the coherent scatter signature is insensitive to the container shape, size, and material. This is because the size and location of the inspection volume is designed to minimize the signal contributions from the container walls. The intensity of the coherent scatter signature, however, depends on the size and composition of the container. This will determine the signal levels and the time required to acquire a statistically significant signal.

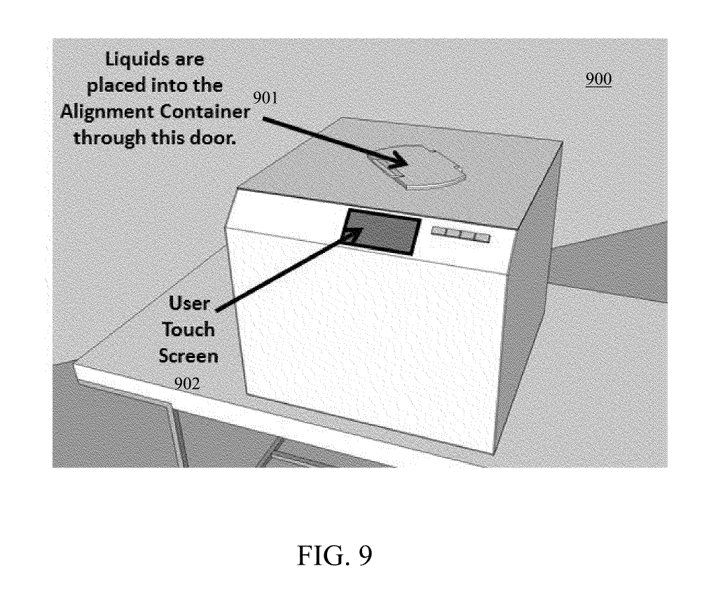

In one embodiment, the present invention uses a CT subsystem to simultaneously screen multiple divested containers packed in a bag. This technique separates threat LAGs from exempt liquids on the basis of where they are located in density-Z_{eff} space. Coherent x-ray scatter techniques are further used to resolve an alarm or to screen benign LAGs that may approach the density and Z_{eff} of threat LAGs. FIG. 9 illustrates one embodiment of such a scanning system 900 which uses a combination of CT and CXS in a compact form factor to provide effective LAGs screening. In one embodiment, the system 900 comprises a low-atomic-number alignment vessel (not shown) into which a bag with a plurality of containers to be screened is placed through the door 901. The alignment vessel helps to reposition the contents of the bag, such that the plurality of bottles or tubes that may be overlapping inside the bag are spaced for screening. The system 900 is equipped with a user interface 902 on the outside for ease of operation.

It may be noted that in the combined CT/CXS system of the present invention, collimation of the incident X-ray beam depends on the active technology—therefore the CT collimator produces a fan-beam during CT scanning, and the CXS collimator delivers a confocal beam during CXS screening. In one embodiment, these two collimators are both located on a single slide that is moved by an actuator into one of two possible positions as needed for each technique.

In one embodiment, the functions of positioning of the collimator, positioning of the alignment container within the X-ray beam for CT and CXS screening, X-ray on/off, and data acquisition are all controlled by dedicated control software.

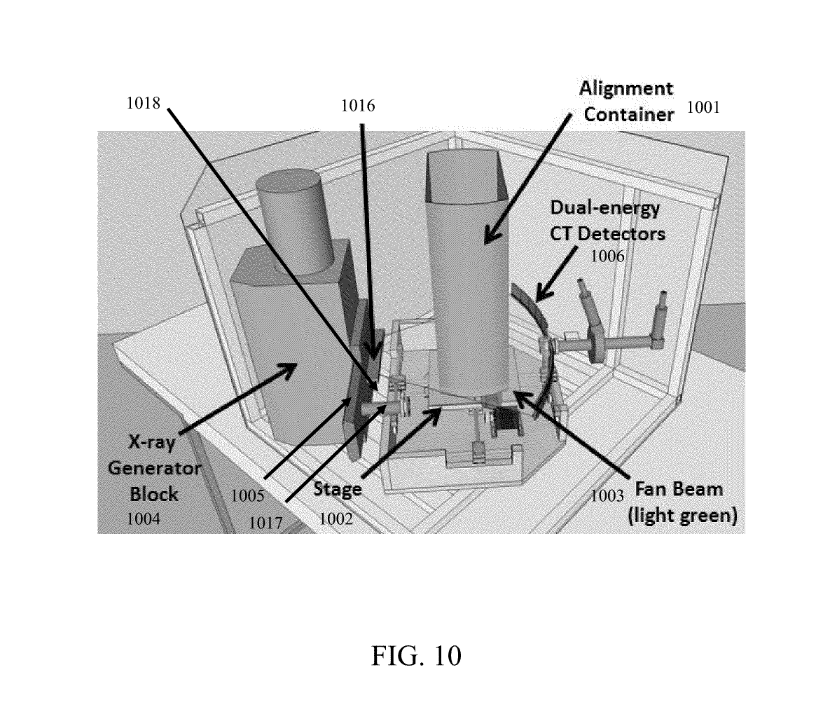

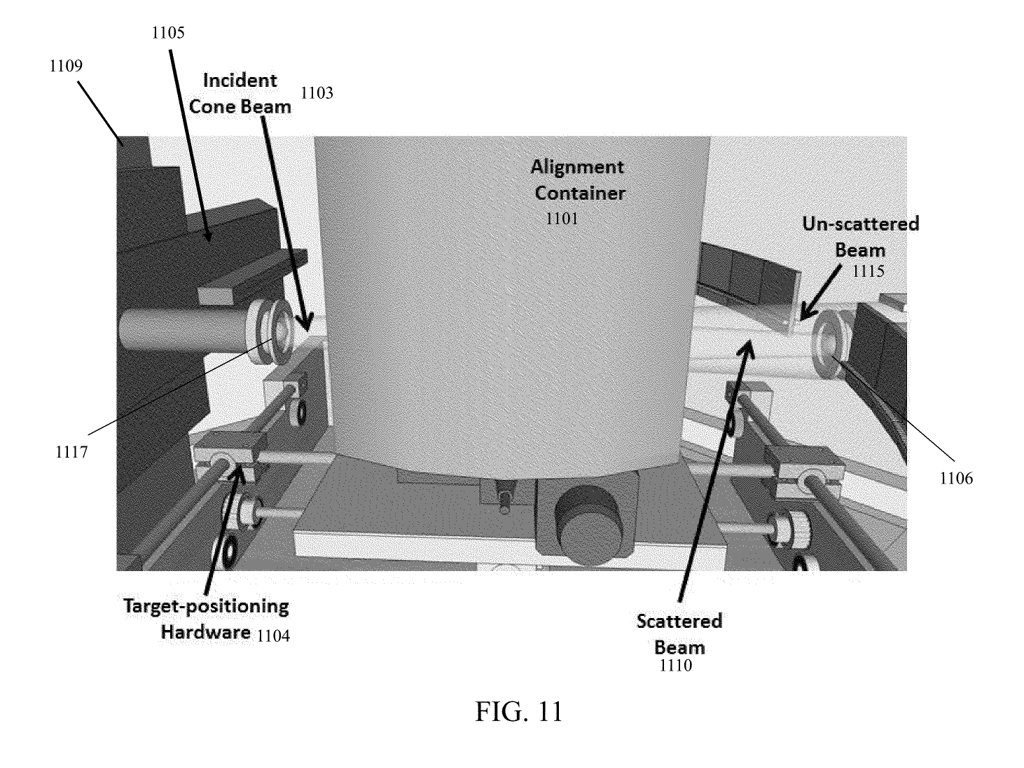

FIG. 10 illustrates in further detail the components of a screening system of present invention. Referring to FIG. 10, a plurality of bottles or tubes containing LAGs are placed inside a plastic alignment vessel 1001 that controls the orientation of the plurality of bottles or containers with respect to the X-ray beam 1003. The alignment vessel 1001 is secured to a stage 1002 that rotates to expose the LAGs (contained with the plurality of bottles or tubes) to a fan X-ray beam 1003 during a CT screening mode, which is the primary mode of inspection. Therefore, the collimator slide 1005 is in a position to employ the appropriate collimator (not shown) to produce a fan beam 1003. In some embodiments, the collimator slide 1005 includes a CT collimator 1016 and a CXS collimator 1017 and is movable between a first position and a second position. In one embodiment, the first position and second position lie within the same horizontal plane. The X-ray generator block 1004 creates a fan shaped beam 1003 through said CT collimator 1016 when the collimator slide 1005 is in the first position. The X-ray generator block 1004 creates a confocal beam through the CXS collimator 1017 when the collimator slide 1005 is in the second position, as discussed with reference to FIG. 11. In one embodiment, a gap 1018 exists between the horizontal slit component 1016 and the CXS collimator of the collimator slide 1005. The fan beam 1003 emitted from the X-ray generator block 1004 is incident upon the constrained LAGs, and the transmitted X-rays are measured by a dual-energy detector array 1006. The output is in the form of a “data slice” that is reconstructed as a CT image using suitable algorithms.

If analysis of the CT image data leads to an alarm, the operator has the option of activating CXS scanning for alarm resolution. In another embodiment, activating CXS scanning is performed automatically as illustrated in FIG. 11. Referring to FIG. 11, in this case, the collimator slide 1105 is moved into the second position to align the CXS collimator 1117 with the X-ray generator block 1109 and produce a confocal beam 1103. Further, a target-positioning mechanism 1104 positions the alarming LAG into position for CXS screening. The alarming LAG positioned inside the alignment vessel 1101, is scanned using the cone beam 1103. Scattered beam 1110 is measured by a CXS detector (not shown) placed behind a detector collimator 1106. The unscattered beam 1115 is measured by a transmission detector (not shown). In one embodiment, DE (Dual Energy) detectors used in the CT subsystem may be used to approximate the transmitted spectra as disclosed in U.S. Pat. No. 7,417,440. Analysis of the CXS data will lead to the original alarm either being cleared or confirmed.

In other embodiments, the CT collimator and the dual-energy detector array are in one horizontal plane, and the CXS collimator and the CXS detector are in another horizontal plane, above (or below) the CT plane. The CT scan is performed with the alignment container in one vertical position, and the CXS measurement (if needed) is performed after moving the alignment container up (or down) so the same location in the object to be examined is measured using the CXS setup. This allows there to not be a gap within the CT detector array, which is advantageous for CT reconstruction without additional artifacts. This embodiment does require movement of the alignment container between CT and CXS measurements.

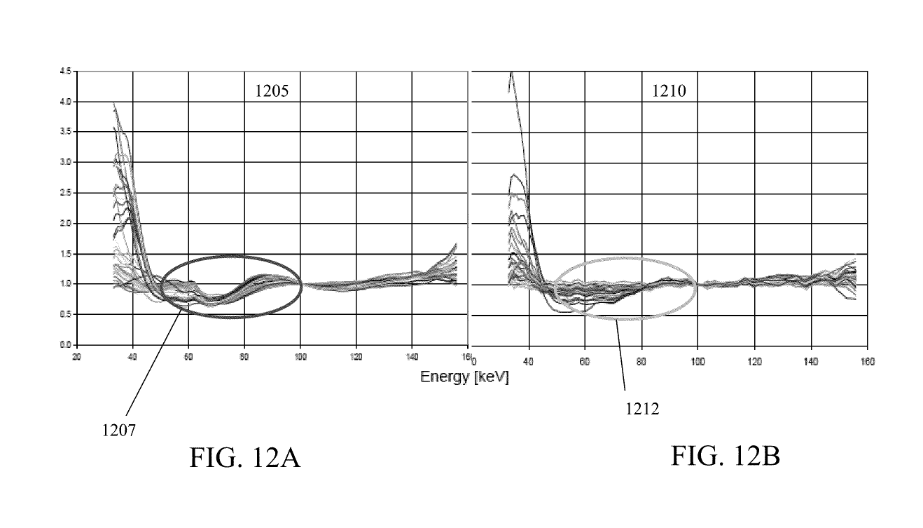

FIG. 12A shows the CXS spectra 1205 from tests on known LAG threats, while FIG. 12B shows spectra 1210 from a variety of benign LAGs such as water, wine, shampoo, etc. Referring to FIGS. 12A and 12B, LAG threat signatures 1207 are clearly distinguishable from the signatures 1212 of the benign liquids, as can be seen by comparing the respective diffraction signatures 1207, 1212 between 50 keV and 100 keV.

In one embodiment, the present specification employs classification algorithms to characterize the results of CXS scanning, such as a minimum distance classifier algorithm and recursive partitioning. The minimum distance classifier algorithm uses the Euclidian distances between the LAG under inspection and threat LAGs stored in a library. The unknown LAG is classified as a threat if the total distance between it and a threat LAG is less than a specified threshold. Recursive partitioning is a statistical method for multivariate analysis that creates a decision tree to correctly classify unknown LAGs.

As explained above, the system of present specification conducts primary inspection using dual-energy CT. Dual-energy CT provides data for an estimation of the primary classification features or properties, density and Z_{eff}. In one embodiment, density information is obtained by the use of a dual-energy reconstruction algorithm based on back-projection or iterative techniques, and Z_{eff} information is derived from measured high- and low-energy x-ray attenuation values. In one embodiment, during primary inspection, contents of the bag carrying the LAGs for inspection are segmented into bottles or partial-bottle regions. All bottles/regions will then be cleared by CT screening, or one or more bottles will be flagged for further analysis by CXS.

Since alarming regions are passed to CXS inspection for more accurate materials classification, in one embodiment a library of CXS threat signatures is used to compare against each targeted region. In one embodiment, the system applies spectroscopic chemical-composition determination algorithms for effective material determination.

The above examples are merely illustrative of the many applications of the system of present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

1. A system for scanning an object, the system comprising:
an X-ray source for generating radiation;
a first scanning subsystem comprising:
a first collimator for limiting the radiation to produce a beam that irradiates the object;
a first array of transmission detectors to generate first transmittance scan data corresponding to detected beam radiation transmitted through the object, wherein the object is rotated about an axis perpendicular to the beam relative to said first array of transmission detectors;
a second scanning subsystem comprising:
a second collimator for limiting the radiation to produce a shaped beam that irradiates the object;
at least one detector to generate scatter scan data corresponding to detected shaped beam radiation scattered from the object; and
a processor that uses said first transmittance scan data and said scatter scan data to determine a presence of a material of interest within said object.

2. The system of claim 1, wherein a first detector in the second scanning subsystem is energy sensitive.

3. The system of claim 1, wherein a second detector is used to measure transmitted radiation through the object in the second scanning subsystem to normalize the scatter scan data.

4. The system of claim 3, wherein the second detector is energy sensitive.

5. The system of claim 3, wherein an attenuator comprising of a pinhole, a filter or a scatterer is used to reduce an intensity of the beam produced by the first collimator.

6. The system of claim 1, wherein the first scanning subsystem is a multi-energy transmission system.

7. The system of claim 1, wherein the X-ray source is switched between a low and a high energy to generate dual-energy transmission data in the first scanning subsystem.

8. The system of claim 1, wherein the beam produced by the first collimator is a fan beam.

9. The system of claim 1, wherein the object is rotated, in increments, by a total angle which is at least a sum of a fan angle of the fan beam and 180 degrees to produce a computed-tomographic image.

10. The system of claim 1, wherein the first scanning subsystem is a multi-energy CT system.

11. The system of claims 1, wherein said processor uses said first transmittance scan data to calculate an effective atomic number and density of voxels within the object and uses said scatter scan data to generate a diffraction signature.

12. The system of claim 11, wherein the processor uses a combination of all or some of the following to determine whether the object contains a material of interest: the diffraction signature, density and effective atomic number.

13. The system of claim 1, wherein the material of interest is one of explosives and drugs.

14. The system of claim 1, wherein the object is a bag containing a combination of liquids, emulsions and gels in individual containers.

15. The system of claim 1, wherein said shaped beam of the second scanning subsystem is a pencil beam.

16. The system of claim 1, wherein said shaped beam of the second scanning subsystem is a ring or a cone shaped beam.

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)
